(19) United States
(12) Patent Application Publication
(10) Pub. No.: US 2014/0225540 A1
(43) Pub. Date: Aug. 14, 2014

(54) CONTROL APPARATUS FOR AC MOTOR

(71) Applicant: Denso Corporation, Kariya-city (JP)

(72) Inventors: Ryuji OMATA, Obu-city (JP); Takeshi ITOH, Nagoya-city (JP); Hirofumi KAKO, Chita-gun (JP)

(73) Assignee: Denso Corporation, Kariya-city (JP)

(21) Appl. No.: 14/174,161

(22) Filed: Feb. 6, 2014

(30) Foreign Application Priority Data
Feb. 8, 2013 (JP) 2013-23303

(51) Int. Cl. H02P 6/00

(52) U.S. Cl. CPC H02P 6/002
USPC 318/400.07

(57) ABSTRACT

In a motor control apparatus for controlling an AC motor with an inverter, a current estimation value is calculated based on a current detection value of one phase of the motor and a rotation angle of the motor. A first voltage command is calculated based on the current estimation value and a current command value related to driving of the motor. A second voltage command is calculated based on information related to an actual behavior of the motor. The information depends on the rotation angle or a phase angle of a current command vector. When a rotation speed of the motor is greater than a threshold, a drive signal related to driving of the inverter is generated based on the first voltage command. When the rotation speed is not greater than the threshold, the drive signal is generated based on the second voltage command.

### CROSS REFERENCE TO RELATED APPLICATION

This application is based on Japanese Patent Application No. 2013-23303 filed on Feb. 8, 2013, the contents of which are incorporated herein by reference.

### FIELD

The present disclosure relates to a control apparatus for an alternating-current (AC) motor.

### BACKGROUND

In recent years, from social demands for low-fuel consumption and low exhaust emission, there has been an increased attention to an electric vehicle or a hybrid vehicle equipped with an alternate-current (AC) motor to run. For example, in a hybrid vehicle, an AC motor is connected to a direct-current (DC) power source such as a rechargeable battery unit through a power converter such as an inverter. The inverter converts a DC voltage supplied from the DC power source to an AC voltage and drives the AC motor with the AC voltage.

JP-A-2008-86139 corresponding to US 2008/0079385 discloses a one-phase control for reducing the number of current sensors used in a control apparatus for an AC motor mounted on an electric vehicle or a hybrid vehicle, thereby reducing the size of the inverter near its output terminals and the cost of a control system of the AC motor. In the one-phase control, a current sensor for detecting a phase current is provided to only one phase of the AC motor.

### SUMMARY

The one-phase control is performed based on a current sensor value of one phase and current estimation values of the other phases Three-phase AC current command values obtained by inverse dq transformation of d-axis and q-axis current command values based on an electrical angle are used as the current estimation values. Since the three-phase AC current command values may not accurately reflect actual currents of the AC motor, control of the AC motor may become unstable.

In particular, when a rotation speed of the AC motor is low, changes in the current sensor value and a rotation angle in a sampling interval at which the current sensor value is detected are small, so that actual information is much reduced. As a result, the control of the AC motor may become more unstable, so that torque may not be accurately outputted.

In view of the above, it is an object of the present disclosure to provide a control apparatus for controlling an AC motor so that the AC motor can accurately output torque even when a rotation speed of the AC motor is low.

According to an aspect of the present disclosure, a control apparatus is used for controlling a three-phase AC motor to which a voltage controlled by an inverter is applied. The control apparatus includes a current receiver, a rotation angle receiver, a rotation speed calculator, a current estimator, a first voltage command value calculator, a second voltage command value calculator, and a control mode switch. The current receiver receives a current detection value from a current sensor provided to one of three phases of the AC motor. The rotation angle receiver receives a rotation angle detection value from a rotation angle sensor that detects a rotation angle of the AC motor. The rotation speed calculator calculates a rotation speed of the AC motor based on the rotation angle detection value. The current estimator calculates a current estimation value based on the current detection value and the rotation angle detection value. The first voltage command value calculator calculates a first voltage command value based on the feedback current estimation value and a current command value related to driving of the AC motor. The second voltage command value calculator calculates a second voltage command value based on actual behavior information related to an actual behavior of the AC motor. The actual behavior information depends on the rotation angle detection value or a phase angle of a current command vector. The control mode switch switches a control mode between a first mode and a second mode based on the rotation speed. When the rotation speed is greater than a predetermined determination threshold, the control mode switch switches the control mode to the first mode. When the rotation speed is not greater than the determination threshold, the control mode switch switches the control mode to the second mode. In the first mode, a drive signal related to driving of the inverter is generated based on the first voltage command value. In the second mode, the drive signal is generated based on the second voltage command value.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating an AC motor drive system according to a first embodiment of the present disclosure;

FIG. 2 is a diagram illustrating a motor drive apparatus according to the first embodiment;

FIG. 3 is a block diagram of a controller according to the first embodiment;

FIG. 4 is a diagram for explaining a phase angle of a current command vector according to the first embodiment;

FIGS. 5A, 5B, and 5C are timing diagrams for explaining a behavior of an AC motor observed when a rotation speed of the AC motor is high;

FIGS. 6A, 6B, and 6C are timing diagrams for explaining a behavior of the AC motor observed when the rotation speed is middle;

FIGS. 7A, 7B, and 7C are timing diagrams for explaining a behavior of the AC motor observed when the rotation speed is low;

FIGS. 8A, 8B, 8C, and 8D are timing diagrams for explaining a behavior of the AC motor observed when the AC motor is controlled based on a voltage command reference value under a condition that the rotation speed is zero;

FIGS. 9A, 9B, 9C, and 9D are timing diagrams for explaining a behavior of the AC motor observed when the AC motor is controlled in a two-phase control mode under a condition that the rotation speed is zero;

FIGS. 10A and 10B are diagrams for explaining a dead-time correction according to the first embodiment;

FIGS. 11A and 11B are diagrams for explaining an amplitude correction according to the first embodiment;

FIGS. 12A, 12B, and 12C are diagrams for explaining a voltage fluctuation occurring when no correction using a voltage correction factor is made under a condition that the rotation speed is low;

FIG. 13 is a diagram for explaining a voltage correction factor according to the first embodiment;

FIG. 14 is a flowchart for explaining a drive control process according to the first embodiment;

FIG. 15 is a flowchart for explaining a FF control procedure according to the first embodiment;

FIGS. 16A, 16B, 16C, 16D, 16E, and 16F are timing diagrams for explaining a behavior of the AC motor according to a reference example;

FIGS. 17A, 17B, 17C, 17D, 17E, and 17F are timing diagrams for explaining a behavior of the AC motor according to the first embodiment;

FIG. 18 is a block diagram of a controller according to a second embodiment of the present disclosure;

FIG. 19 is a flowchart for explaining a drive control process according to the second embodiment; and

FIG. 20 is a flowchart for explaining a voltage command value read procedure according to the second embodiment.

### DETAILED DESCRIPTION

A control apparatus for an AC motor according to the present disclosure is described below with reference to the drawings. Throughout embodiments, the same reference characters refer to similar parts.

### First Embodiment

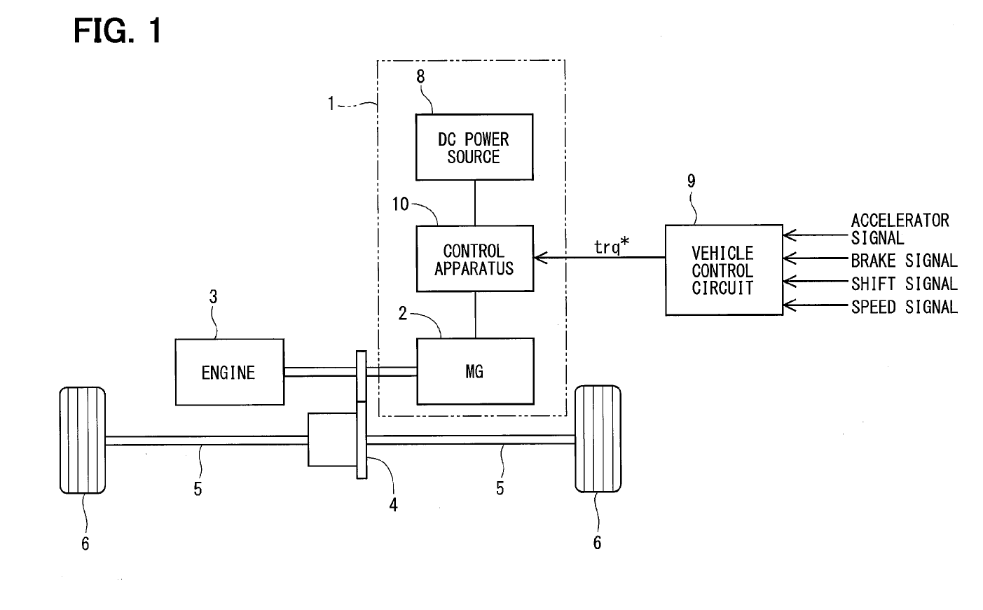

As shown in FIG. 1, a motor control apparatus 10 according to a first embodiment of the present disclosure is applied to a motor drive system 1 for driving a motor-operated vehicle.

The motor drive system 1 includes an AC motor 2, a DC power source 8, and the motor control apparatus 10.

For example, the AC motor 2 can be a motor for generating torque to drive a drive wheel 6 of the motor-operated vehicle. According to the first embodiment, the AC motor 2 is a permanent magnet three-phase synchronous motor.

The motor-operated vehicle is a vehicle that uses electric power to drive the drive wheel 6. Examples of the motor-operated vehicle can include a hybrid vehicle, an electric vehicle, and a fuel cell vehicle. According to the first embodiment, the motor-operated vehicle is a hybrid vehicle with an engine 3, and the AC motor 2 is a so-called motor generator (MG) serving as not only a motor to generate torque to drive the drive wheel 6 but also a generator to generate electric power by being driven with kinetic energy transmitted from the engine 3 and the drive wheel 6.

The AC motor 2 is connected to an axle 5 of the vehicle through a gear 4 such as a transmission so that torque of the AC motor 2 can be transmitted to the axle 5 though the gear 4. Thus, the axle 5 is rotated so that the drive wheel 6 can be driven.

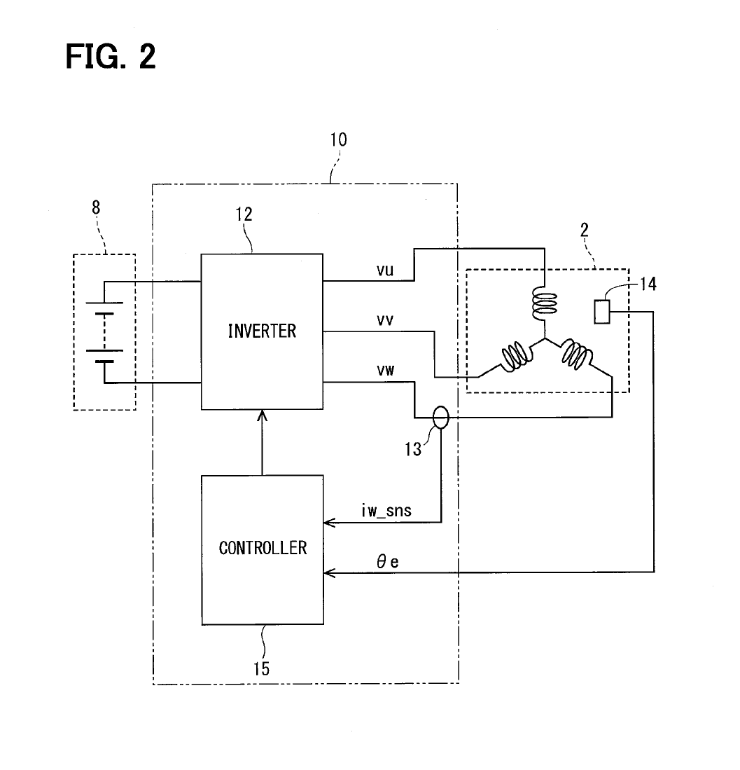

The DC power source 8 is a rechargeable power storage device such as an electric double-layer capacitor or a secondary battery such as a lithium-ion battery or a nickel hydride battery. The DC power source 8 is connected to an inverter 12 (refer to FIG. 2) of the motor control apparatus 10 and exchanges electric power with the AC motor 2 through the inverter 12.

For example, a vehicle control circuit 9 is configured as a microcomputer and includes a CPU, a ROM, and an I/O that are connected through buses. The vehicle control circuit 9 controls the whole of the vehicle by software by executing prestored programs using the CPU or by hardware using a specific electronic circuit.

The vehicle control circuit 9 is capable of receiving signals from sensors and switches. For example, the vehicle control circuit 9 can receive an accelerator signal from an accelerator sensor (not shown), a brake signal from a brake sensor (not shown), a shift signal from a shift switch (not shown), and a speed signal from a vehicle speed sensor (not shown). The vehicle control circuit 9 detects operating conditions of the vehicle based on the received signals and outputs a torque command value trq* to the motor control apparatus 10 according to the operating conditions. Further, the vehicle control circuit 9 outputs a command signal to an engine control circuit (not shown) that controls operations of the engine 3.

As shown in FIG. 2, the motor control apparatus 10 includes the inverter 12 and a controller 15.

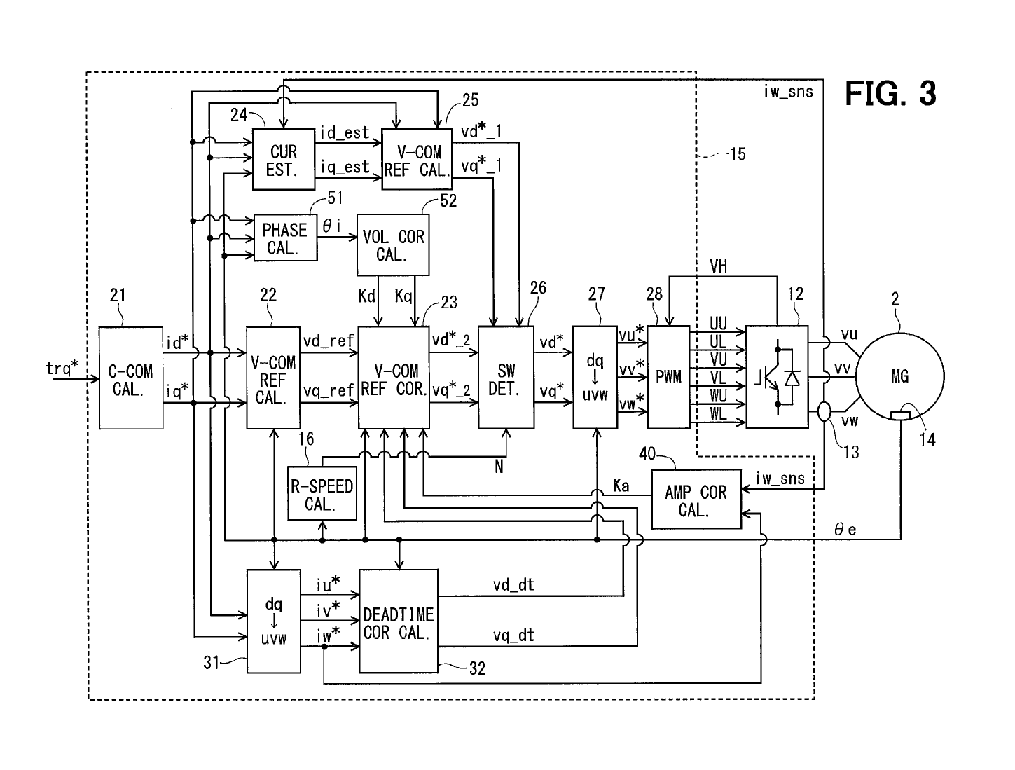

An inverter input voltage VH is applied to the inverter 12 according to driving conditions of the AC motor 2 and vehicle requests. The inverter input voltage VH is generated by stepping up a DC voltage of the DC power supply 8 using a step-up converter (not shown). The inverter 12 includes six switching devices (not shown) connected in a bridge configuration. The six switching devices include three high-potential-side switching devices (hereinafter referred to as “upper switching devices”) and three low-potential-side switching devices (hereinafter referred to as “lower switching devices”). Each upper switching device is connected in series to a corresponding one of the lower switching devices to form a leg circuit. Each leg circuit is provided to a corresponding one of three phases of the AC motor 2. Examples of the switching device include an insulated-gate bipolar transistor (IGBT), a metal oxide semiconductor (MOS) transistor, and a bipolar transistor. The switching devices are controlled (i.e., turned ON and OFF) based on PWM signals UU, UL, VU, VL, WU, and WL outputted from a PWM signal generator 28 (refer to FIG. 3) of the controller 15 so that the inverter 12 can control three-phase AC voltages vu, vv, and vw applied to the AC motor 2. The AC motor 2 is controlled (i.e., driven) by the three-phase AC voltages vu, vv, and vw generated and applied by the inverter 12.

It is noted that a short-circuit occurs through the upper and lower switching devices, if both the upper and lower switching devices are ON during a transition from a state where the upper switching device is ON and the lower switching device is OFF to a state where the upper switching device is OFF and the lower switching device is ON, or during a transition from a state where the upper switching device is OFF and the lower switching device is ON to a state where the upper switching device is ON and the lower switching device is OFF. To prevent such a short-circuit, according to the first embodiment, a deadtime Tdt where both the upper and lower switching devices are OFF is provided. The deadtime Tdt is preset to a predetermined value by switching device design and stored in a memory section (not shown) of the controller 15.

A current sensor 13 is provided to any one of the three phases of the AC motor 2. According to the first embodiment, the current sensor 13 is provided to the W-phase of the AC motor 2. The W-phase to which the current sensor 13 is provided hereinafter referred to as a “sensor-phase”. The current sensor 13 detects a phase current of the W-phase as the sensor-phase and outputs a W-phase current detection value iw_sns indicative of the detected phase current to the controller 15. The controller 15 receives the W-phase current detection value iw_sns. Alternatively, the U-phase or the V-phase instead of the W-phase can be the sensor-phase.

A rotation angle sensor 14 is located near a rotor (not shown) of the AC motor 2. The rotation angle sensor 14 detects an electrical angle θe and outputs the electrical angle θe to the controller 15. The controller 15 receives the electrical angle θe. According to the first embodiment, the rotation angle sensor 14 is a resolver. Alternatively, the rotation angle sensor 14 can be a rotary encoder or the like.

The AC motor 2 is controlled as follows. Based on a rotation speed N of the rotor of the AC motor 2 (hereinafter referred to simply as the “rotation speed N of the AC motor 2”), which is calculated from the electrical angle θe detected by the rotation angle sensor 14, and the torque command value trq*, which is received from the vehicle control circuit 9, the motor control apparatus 10 causes the AC motor 2 to consume power by performing a motoring operation as a motor or to generate power by performing a regeneration operation as a generator. Specifically, the motor control apparatus 10 causes the AC motor 2 to operate in one of the following four modes based on a sign (i.e., positive or negative) of the rotation speed N and a sign of the torque command value trq*.

<First mode> forward rotation/forward torque (power consumption)

<Second mode> forward rotation/reverse torque (power generation)

<Third mode> reverse rotation/reverse torque (power consumption)

<Fourth mode> reverse rotation/forward torque (power generation)

When the rotation speed N is greater than 0 (i.e., forward rotation) and the torque command value trq* is greater than 0, or when the rotation speed N is less than 0 (i.e., reverse rotation) and the torque command value trq* is less than 0, the inverter 12 converts DC power supplied from the DC power source 8 to AC power by switching operations of the switching devices and supplies the AC power to the AC motor 2 so that the AC motor 2 can output torque. Thus, the AC motor 2 performs the motoring operation.

In contrast, when the rotation speed N is greater than 0 (i.e., forward rotation) and the torque command value trq* is less than 0, or when the rotation speed N is less than 0 (i.e., reverse rotation) and the torque command value trq* is greater than 0, the inverter 12 converts AC power generated by the AC motor 2 to DC power by switching operations of the switching devices and supplies the DC power to the DC power source 8 so that the DC power source 8 can be charged. Thus, the AC motor 2 performs the regeneration operation.

Next, the controller 15 is described in detail with reference to FIG. 3. As shown in FIG. 3, the controller 15 includes a rotation speed calculator 16, a current command value calculator 21, a voltage command reference value calculator 22, a voltage command reference value corrector 23, a current estimator 24, a voltage command value calculator 25, a switch determinator 26, a three-phase voltage command value calculator 27, the PWM signal generator 28, a three-phase current command value calculator 31, a dead-time correction value calculator 32, an amplitude correction factor calculator 40, a phase calculator 51, and a voltage correction factor calculator 52.

The rotation speed calculator 16 calculates the rotation speed N of the AC motor 2 based on the electrical angle θe.

Based on the torque command value trq* received from the vehicle control circuit 9, the current command value calculator 21 calculates a d-axis current command value id* and a q-axis current command value iq* in a rotating coordinate system (d-q coordinate system) of the AC motor 2. According to the first embodiment, the d-axis current command value id* and the q-axis current command value iq* are calculated by referring to a prestored mapping table. Alternatively, the d-axis current command value id* and the q-axis current command value iq* can be calculated from a formula or the like.

The voltage command reference value calculator 22 calculates d-axis and q-axis voltage command reference values vd_ref and vq_ref based on the d-axis and q-axis current command values id* and iq* by using voltage equations as theoretical formulas for a motor. The d-axis and q-axis voltage command reference values vd_ref and vq_ref are derived directly from the d-axis and q-axis current command values id* and iq* and therefore can be regarded as a feedforward (FF) term.

The voltage command reference value corrector 23 calculates second d-axis and q-axis voltage command values vd*_{—}2 and vq*_{—}2 by correcting the d-axis and q-axis voltage command reference values vd_ref and vq_ref, respectively.

A method by which the voltage command reference value calculator 22 calculates the d-axis and q-axis voltage command reference values vd_ref and vq_ref and a method by which the voltage command reference value corrector 23 calculates the second d-axis and q-axis voltage command values vd*_{—}2 and vq*_{—}2 calculates are described in detail later.

The current estimator 24 calculates d-axis and q-axis current estimation values id_est and iq_est based on the W-phase current detection value iw_sns and the electrical angle θe. According to the first embodiment, the d-axis and q-axis current estimation values id_est and iq_est are calculated based on the d-axis and q-axis current command values id* and iq* in addition to the W-phase current detection value iw_sns and the electrical angle θe. Specifically, U-phase and V-phase current command values iu* and iv*, which are calculated by inverse dq transformation of the d-axis and q-axis current command values id* and iq*, are used as U-phase and V-phase current estimation values iu_est and iv_est. Then, the d-axis and q-axis current estimation values id_est and iq_est are calculated by dq transformation of the U-phase and V-phase current estimation values iu_est and iv_est and the W-phase current detection value iw_sns.

The d-axis and q-axis current estimation values id_est and iq_est can be calculated based on the W-phase current detection value iw_sns and the electrical angle θe by any other method than that described above. Likewise, the U-phase and V-phase current estimation values iu_est and iv_est can be calculated by any other method than that described above. If the U-phase and V-phase current estimation values iu_est and iv_est are unnecessary for the calculation of the d-axis and q-axis current estimation values id_est and iq_est, there is no need to calculate the U-phase and V-phase current estimation values iu_est and iv_est.

The voltage command value calculator 25 calculates a d-axis current difference Δid between the d-axis current estimation value id_est, which is fed back from the current estimator 24, and the d-axis current command value id* and calculates a first d-axis voltage command value vd*_{—}1 by PI calculation so that the d-axis current difference Δid can converge to zero [A], thereby causing the d-axis current estimation value id_est to follow the d-axis current command value id*. Likewise, the voltage command value calculator 25 calculates a q-axis current difference Δiq between the q-axis current estimation value iq_est, which is fed back from the current estimator 24, and the q-axis current command value iq* and calculates a first q-axis voltage command value vq*_{—}1 by PI calculation so that the q-axis current difference Δiq can converge to zero [A], thereby causing the q-axis current estimation value iq_est to follow the q-axis current command value iq*.

The switch determinator 26 selects the first d-axis and q-axis voltage command values vd*_{—}1 and vq*_{—}1 or the second d-axis and q-axis voltage command values vd*_{—}2 and vq*_{—}2 as the d-axis and q-axis voltage command values vd* and vq* used to calculate drive signals (i.e., the PWM signals UU, UL, VU, VL, WU, and WL) for driving the inverter 12. According to the first embodiment, when the rotation speed N is greater than a predetermined determination threshold A, the switch determinator 26 selects the first d-axis and q-axis voltage command values vd*_{—}1 and vq*_{—}1 as the d-axis and q-axis voltage command values vd* and vq*. In contrast, when the rotation speed N is not greater than the determination threshold A, the switch determinator 26 selects the second d-axis and q-axis voltage command values vd*_{—}2 and vq*_{—}2 as the d-axis and q-axis voltage command values vd* and vq*.

Controlling the AC motor 2 by generating the drive signals for driving the inverter 12 based on the first d-axis and q-axis voltage command values vd*_{—}1 and vq*_{—}1 is hereinafter referred to as an “estimation current feedback (FB) control mode”. The estimation current FB control mode can be regarded as a one-phase control using a current detection value (e.g., W-phase current detection value iw_sns) of one phase of the AC motor 2. In contrast, controlling the AC motor 2 by generating the drive signals for driving the inverter 12 based on the second d-axis and q-axis voltage command values vd*_{—}2 and vq*_{—}2 is hereinafter referred to as a “FF voltage command control mode” (hereinafter referred to simply as the “FF control mode”). The estimation current FB control mode corresponds to a first mode recited in claims, and the FF control mode corresponds to a second mode recited in claims. According to the first embodiment, since the current sensor 13 is provided to only one phase of the AC motor 2, not only the estimation current FB control mode but also the FF control mode can be regarded as the one-phase control in a broad sense.

According to the first embodiment, a control mode of the AC motor 2 is switched between the estimation current FB control mode and the FF control mode based on the rotation speed N. Specifically, when the rotation speed N is greater than the determination threshold A, the AC motor 2 is controlled in the estimation current FB control mode, and when the rotation speed N is not greater than the determination threshold A, the AC motor 2 is controlled in the FF control mode.

The three-phase voltage command value calculator 27 performs inverse dq transformation based on the electrical angle θe received from the rotation angle sensor 14 so that the d-axis and q-axis voltage command values vd* and vq* can be converted to a U-phase voltage command value vu*, a V-phase voltage command value vv*, and a W-phase voltage command value vw*.

The PWM signal generator 28 calculates the PWM signals UU, UL, VU, VL, WU, and WL based on the three-phase voltage command values vu*, vv*, and vw* and the inverter input voltage VH applied to the inverter 12.

The switching devices of the inverter 12 are turned ON and OFF based on the PWN signals UU, UL, VU, VL, WU, and WL so that the three-phase AC voltages vu, vv, and vw can be generated. The three-phase AC voltages vu, vv, and vw are applied to the AC motor 2 to control the AC motor 2 so that the AC motor 2 can output torque corresponding to the torque command value trq*. The three-phase AC voltages vu, vv, and vw correspond to an application voltage recited in claims.

The three-phase current command value calculator 31 performs inverse dq transformation based on the electrical angle θe so that the d-axis and q-axis current command values id* and iq* can be converted to the U-phase current command value iu*, the V-phase current command value iv*, and a W-phase current command value iw*. The U-phase current command value iu*, the V-phase current command value iv*, and the W-phase current command value iw* are hereinafter referred to simply as the “three-phase current command values iu*, iv*, and iw*”.

The dead-time correction value calculator 32 calculates d-axis and q-axis dead-time correction values vd_dt and vq_dt according to a voltage error due to the dead time Tdt during which both the upper and lower switching devices remain OFF.

The amplitude correction factor calculator 40 calculates an amplitude correction factor Ka based on the W-phase current detection value iw_sns and the W-phase current command value iw*.

Details of the d-axis and q-axis dead-time correction values vd_dt and vq_dt and the amplitude correction factor Ka are described later.

The phase calculator 51 calculates a phase angle θi of a current command value current command vector i*.

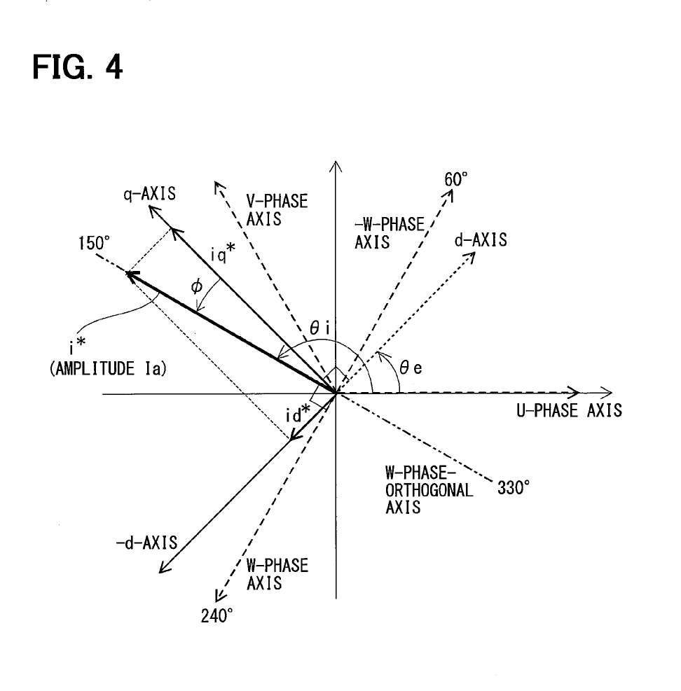

The phase angle θi of the current command vector i* is described with reference to FIG. 4. As shown in FIG. 4, according to the first embodiment, the electrical angle θe is measured with respect to a U-phase axis as 0° in a counterclockwise direction, and a W-phase axis is shifted from the U-phase axis by an electrical angle of 240°.

In a dq coordinate system, a phase φ of the current command vector i*, in which a d-axis component is the d-axis current command value id* and a q-axis component is the q-axis current command value iq*, is defined in a counterclockwise direction from the q-axis. The phase angle θi of the current command vector i* with respect to the U-phase axis is given by the following formula (1). The phase angle θi of the current command vector i* with respect to the U-phase axis is hereinafter referred to simply as the phase angle θi.

θi=θe+φ+90° (1)

When a reference axis is not specified, the formula (1) can be generalized to the following formula (2), where C represents a constant.

θi=θe+φ+C (2)

The voltage correction factor calculator 52 calculates d-axis and q-axis voltage correction factors Kd and Kq based on the phase angle θi.

A method by which the voltage correction factor calculator 52 calculates the d-axis and q-axis voltage correction factors Kd and Kq is described later.

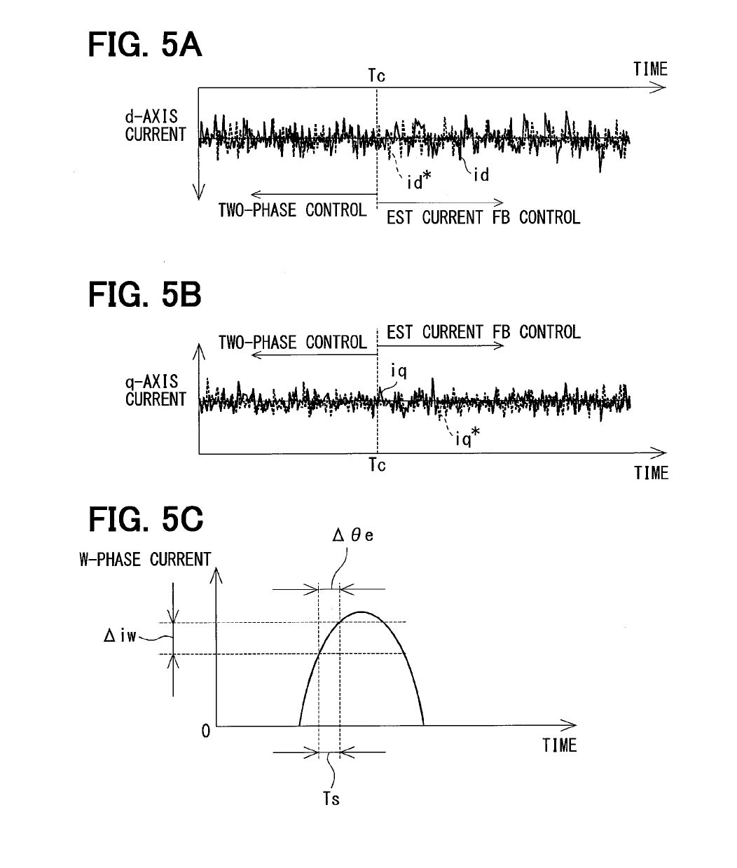

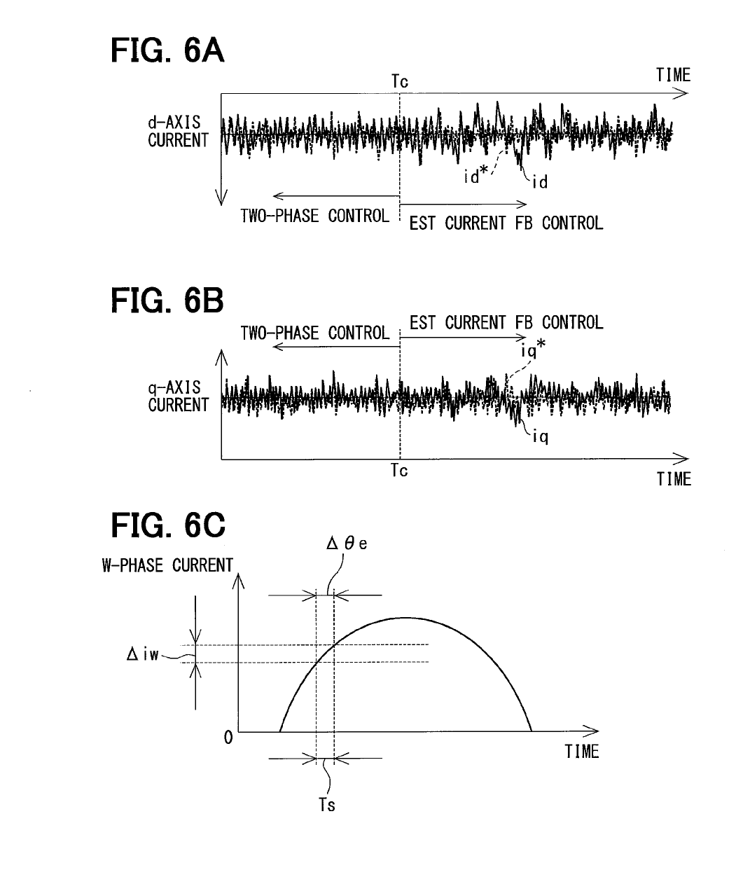

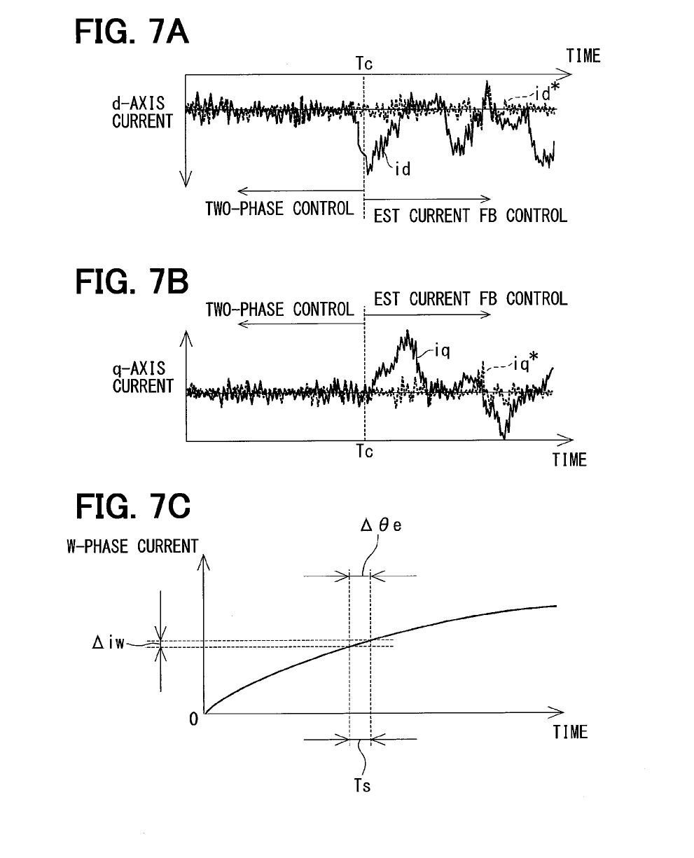

Next, the estimation current FB control mode is described below with reference to FIGS. 5A-5C, 6A-6C, and 7A-7C. FIGS. 5A-5C show a case where the rotation speed N of the AC motor 2 is high, FIGS. 6A-6C show a case where the rotation speed N of the AC motor 2 is middle, and FIGS. 7A-7C show a case where the rotation speed N of the AC motor 2 is low. The terms “low rotation speed”, “middle rotation speed”, and “high rotation speed” are used in a relative sense and are not meant to describe concrete rotation speeds of the AC motor 2. That is, when the rotation speed N related to FIGS. 5A-5C is defined as N1, the rotation speed N related to FIGS. 6A-6C is defined as N2, and the rotation speed N related to FIGS. 7A-7C is defined as N3, the following relationship is satisfied: N1≦N2≦N3. A sampling interval Ts at which a current sensor detects a phase current of the AC motor 2 is uniform among FIGS. 5A-5C, 6A-6C, and 7A-7C. FIGS. 5A, 6A, and 7A represent a d-axis current. FIGS. 5B, 6B, and 7B represent a q-axis current. FIGS. 5C, 6C, and 7C represent a relationship among the sampling interval Ts, an electrical angle change Δθe, and a current change Δiw. In FIGS. 5A, 5B, 6A, 6B, 7A, and 7B, a solid line represents an actual value, and a broken line represents a command value. Further, in FIGS. 5A, 5B, 6A, 6B, 7A, and 7B, the control mode of the AC motor 2 is switched at a time Tc to the estimation current FB control mode, where the AC motor 2 is controlled based on a current detection value of one phase (e.g., W-phase current detection value iw_sns in the first embodiment), from a two-phase control mode, where two current sensors are separately provided to two phases of the AC motor 2, and the AC motor 2 is controlled based on current detection values of the two phases.

As shown in FIGS. 5A and 5B, when the control mode is switched form the two-phase control mode to the estimation current FB control mode under a condition that the rotation speed N is high, fluctuations in the d-axis and q-axis current actual values id and iq in the estimation current FB control mode are almost the same as those in the two-phase control mode.

A reason for this is that as shown in FIG. 5C, when the sampling interval Ts is constant regardless of the rotation speed N, the electrical angle change Δθe and the current change Δiw in the sampling interval Ts are relatively large. Therefore, even in the estimation current FB control mode, it is likely that actual information is suitably reflected.

As shown in FIGS. 6A and 6B, when the control mode is switched form the two-phase control mode to the estimation current FB control mode under a condition that the rotation speed N is middle, the fluctuations in the d-axis and q-axis current actual values id and iq in the estimation current FB control mode become greater than those in the two-phase control mode. As a result, the control of the AC motor 2 becomes unstable.

A reason for this is that as shown in FIG. 6C, since the electrical angle change Δθe and the current change Δiw in the sampling interval Ts are smaller than those when the rotation speed N is high, the actual information is reduced.

As shown in FIGS. 7A and 7B, when the control mode is switched form the two-phase control mode to the estimation current FB control mode under a condition that the rotation speed N is low, the fluctuations in the d-axis and q-axis current actual values id and iq in the estimation current FB control mode become greater than those when the rotation speed N is middle. As a result, the control of the AC motor 2 becomes more unstable.

As shown in FIG. 7C, when the rotation speed N is low, the electrical angle change Δθe and the current change Δiw in the sampling interval Ts become almost zero. According to the first embodiment, the U-phase and V-phase current command values iu* and iv* are used as the U-phase and V-phase current estimation values iu_est and iv_est, respectively. Therefore, when the current change Δiw changing with respect to the command becomes almost zero, the d-axis and q-axis current estimation values id_est and iq_est to be fed back change little.

As described above, when the rotation speed N is low, the electrical angle change Δθe and the current change Δiw in the sampling interval Ts become small. In other words, the actual information reflected in the d-axis and q-axis current estimation values id_est and iq_est to be fed back becomes insufficient. As a result, accuracy of the d-axis and q-axis current estimation values id_est and iq_est to be fed back may be reduced. Therefore, when the AC motor 2 is controlled in the estimation current FB control mode under a condition that the rotation speed N is low, the control of the AC motor 2 may become unstable.

For the above reason, according to the first embodiment, when the rotation speed N is not greater than the determination threshold A, the FF control mode is used instead of the estimation current FB control mode to control the AC motor 2 based on the second d-axis and q-axis voltage command values vd*_{—}2 and vq*_{—}2 by correcting the FF term.

The d-axis and q-axis voltage command reference values vd_ref and vq_ref calculated by the voltage command reference value calculator 22 are described. In general, voltage equations of a motor are given by the following formulas (3.1) and (3.2).

vd=Ra×id+Ld×(d/dt)id−ω×Lq×iq (3.1)

vq=Ra×iq+Lq×(d/dt)iq+ω×Ld×id+ω×ψ (3.2)

The formulas (3.1) and (3.2) can be respectively rewritten into the following formulas (4.1) and (4.2) by ignoring the time-derivative term (d/dt) as transient property, by using the d-axis and q-axis current command values id* and iq* as d-axis and q-axis current values id and iq, and by using the d-axis and q-axis voltage command reference values vd_ref and vq_ref as d-axis and q-axis voltage values vd and vq.

vd_ref=Ra×id*−ω×Lq×iq* (4.1)

vq_ref=Ra×iq*+ω×Ld×id*+ω×ψ (4.2)

In the formulas (3.1), (3.2), (4.1), and (4.2), Ra represents an armature resistance, Ld represents a d-axis self-inductance, Lq represents a q-axis self-inductance, ω represents an electrical angular velocity, and ψ represents an armature interlinkage magnetic flux of a permanent magnet.

The armature resistance Ra, the d-axis self-inductance Ld, the q-axis self-inductance Lq, and the armature interlinkage magnetic flux ψ are machine constants of the AC motor 2. The machine constants can be fixed values or calculated values. For example, the machine constants can be calculated based on the torque command value trq* (or the d-axis and q-axis current command values id* and iq*) by using a mapping table which is created in advance with actual measurement values or values having almost actual characteristics.

The electrical angular velocity ω is calculated by the voltage command reference value calculator 22 based on the electrical angle θe. Alternatively, the electrical angular velocity ω can be calculated based on the rotation speed N.

When the rotation speed N is zero [rpm], the electrical angular velocity ω also becomes zero [rad/s]. Therefore, the term of the electrical angular velocity ω in each of the formulas (4.1) and (4.2) becomes zero, so that only the resistance term is left as shown in the following formulas (5) and (6).

vd_ref=Ra×id* (5)

vq_ref=Ra×iq* (6)

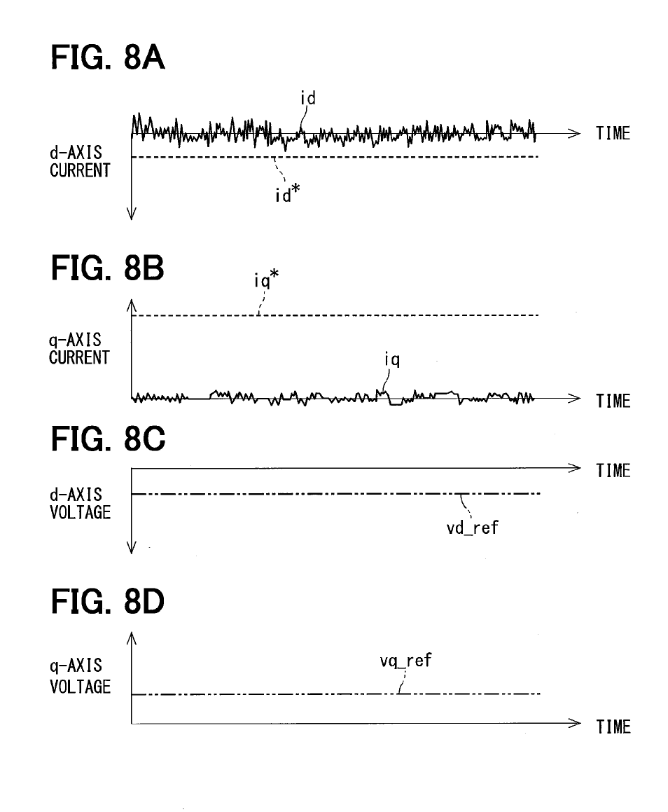

As can be seen from the formulas (5) and (6), when the rotation speed N is zero, the d-axis and q-axis voltage command reference values vd_ref and vq_ref depend on the armature resistance Ra and become small depending on the armature resistance Ra and the current command value. Further, due to physical factors of the AC motor 2 and the motor control apparatus 10, the theoretical voltage command reference values calculated from the voltage equations may deviate from voltage command values necessary for the AC motor 2 to actually output torque corresponding to the torque command value trq*. Therefore, when the AC motor 2 is controlled based on the d-axis and q-axis voltage command reference values vd_ref and vq_ref calculated from the voltage equations, the d-axis and q-axis current actual values id and iq flowing through the AC motor 2 may become almost zero as shown in FIGS. 8A and 8B. As a result, torque necessary to actually drive the AC motor 2 is not generated, so that the AC motor 2 cannot be started up.

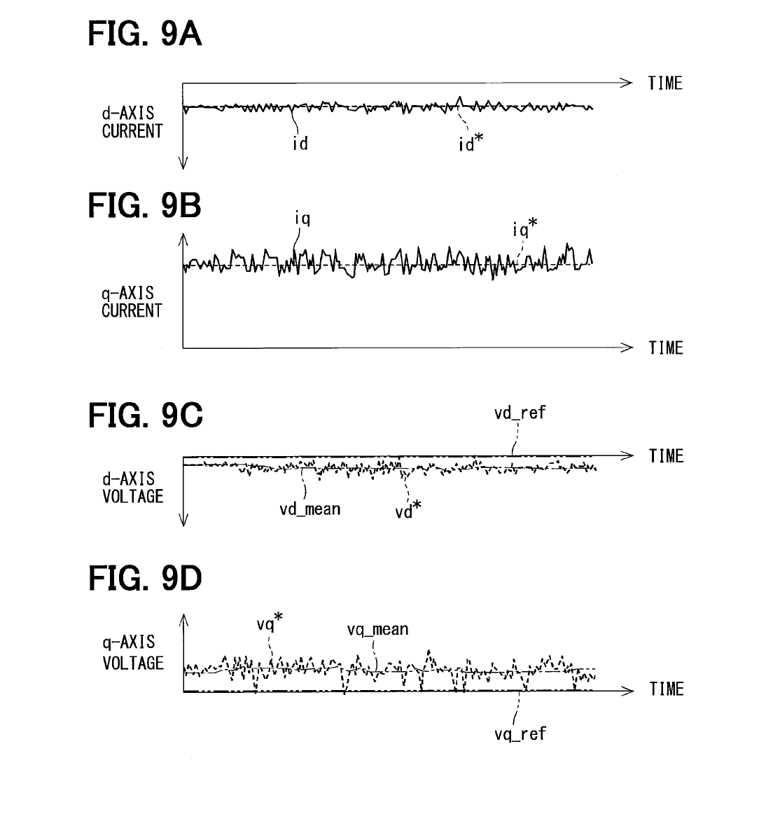

FIGS. 9A-9D show a behavior of the AC motor 2 observed when the AC motor 2 is controlled in the two-phase control mode under a condition that the rotation speed N is zero. As shown in FIGS. 9A-9D, voltages are applied to the AC motor 2 based on the d-axis and q-axis voltage command values vd* and vq* having absolute values greater than those of the d-axis and q-axis voltage command reference values vd_ref and vq_ref so that the d-axis and q-axis current actual values id and iq corresponding to the d-axis and q-axis current command values id* and iq* can flow through the AC motor 2.

It is noted that FIGS. 8A and 9A represent a d-axis current, FIGS. 8B and 9B represent a q-axis current, FIGS. 8C and 9C represent a d-axis voltage, and FIGS. 8D and 9D represent a q-axis voltage. In FIGS. 5A, 5B, 6A, 6B, 7A, and 7B, a solid line represents an actual value, and a broken line represents a command value. In FIGS. 8A, 8B, 9A, and 9B, a solid line represents an actual value, and a broken line represents a command value. In FIG. 8C, the d-axis voltage command reference value vd_ref is represented by a two-dot chain line. In FIG. 8D, the d-axis voltage command value vd* calculated in the two-phase control mode is represented by a broken line, and a mean value vd_mean of the d-axis voltage command value vd* is represented by a chain line. In FIG. 9C, the q-axis voltage command reference value vq_ref is represented by a two-dot chain line. In FIG. 9D, the q-axis voltage command value vq* calculated in the two-phase control mode is represented by a broken line, and a mean value vq_mean of the q-axis voltage command value vq* is represented by a chain line. Further, as a reference, the d-axis and q-axis voltage command values vd* and vq* shown in FIGS. 8C and 8D are indicated in FIGS. 9C and 9D, respectively, after conversion to their equivalent values in the ranges of FIGS. 9C and 9D.

According to the voltage equations, the d-axis and q-axis voltage command values vd* and vq* applied in the two-phase control mode under a condition that the rotation speed N is zero can be represented by the following formulas (7) and (8).

vd*=Ra×id*+vd_cmp (7)

vq*=Ra×iq*+vq_cmp (8)

That is, in the two-phase control mode, the voltage command values are increased by feedback control until a current corresponding to the d-axis and q-axis current command values id* and iq* flows through the AC motor 2. Therefore, it can be considered that d-axis and q-axis voltage command correction values vd_cmp and vq_cmp are generated by the feedback control. The d-axis and q-axis voltage command correction values vd_cmp and vq_cmp correspond to differences between the theoretical voltage command reference values calculated from the voltage equations and the voltage command values necessary for the AC motor 2 to actually output torque corresponding to the torque command value trq*.

According to the first embodiment, the dead time Tdt is set to prevent a short-circuit occurring when the upper and lower switching devices of the inverter 12 are turned ON at the same time. The dead time Tdt may cause a voltage actually applied to the AC motor 2 to deviate from a theoretical voltage. The influence of a voltage error due to the difference between the actual and theoretical voltages becomes larger, as the torque and rotation speed N of the AC motor 2 are lower.

For the above reason, according to the first embodiment, the d-axis and q-axis voltage command correction values vd_cmp and vq_cmp in the formulas (7) and (8) are regarded as a voltage error due to the dead-time Tdt, the dead-time correction value calculator 32 calculates the d-axis and q-axis dead-time correction values vd_dt and vq_dt, and the voltage command reference value corrector 23 corrects the d-axis and q-axis voltage command reference values vd_ref and vq_ref.

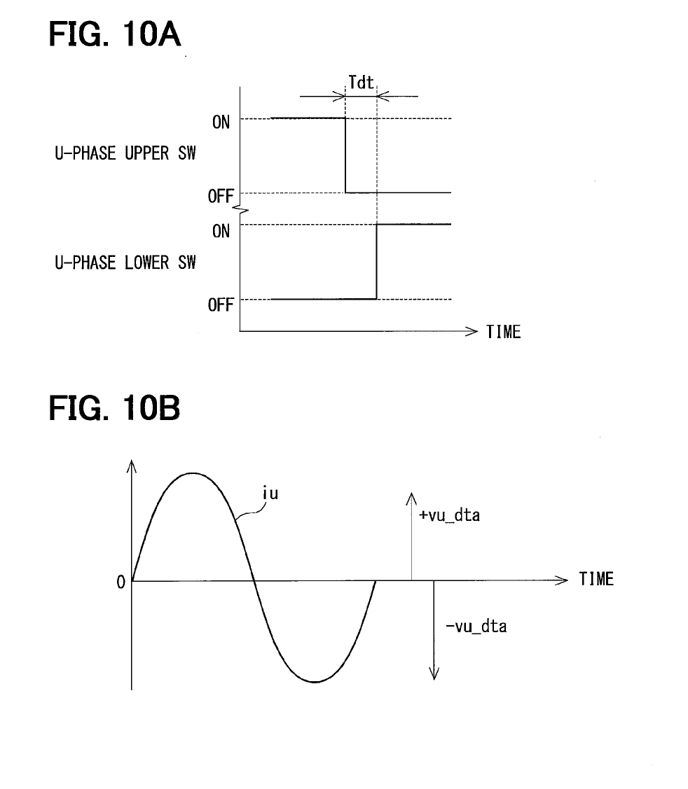

Next, the method of calculating the d-axis and q-axis dead-time correction values vd_dt and vq_dt is described with reference to FIGS. 10A and 10B.

FIG. 10A shows a manner in which the upper and lower switching devices of the leg circuit corresponding to the U-phase of the AC motor 2 are turned ON and OFF. As mentioned previously, if both the upper and lower switching devices are ON during a transition from a state where the upper switching device is ON and the lower switching device is OFF to a state where the upper switching device is OFF and the lower switching device is ON, a short-circuit occurs through the upper and lower switching devices. To prevent such a short-circuit, the deadtime Tdt where both the upper and lower switching devices are OFF is provided. The deadtime Tdt is preset to a predetermined value by switching device design. The voltage error depends on a ratio of the deadtime Td to an ON-period of the switching device. The same is true for a transition from a state where the upper switching device is OFF and the lower switching device is ON to a state where the upper switching device is ON and the lower switching device is OFF. Also, the same is true for the V-phase and the W-phase.

Dead-time correction values vu_dta, vv_dta, and vw_dta for each phase are given by the following formula (9), where fc represents a frequency of a triangular wave used to generate the PWM signals, and VH represents the inverter input voltage.

vu_dta=vv_dta=vw_dta=Tdt×fc×VH (9)

As shown in FIG. 10B, when the U-phase current value iu is positive, the dead-time correction values vu_dta is added, and when the U-phase current value iu is negative, the dead-time correction values vu_dta is subtracted. The same is true for the V-phase and the W-phase.

According to the first embodiment, since neither the U-phase nor the V-phase is provided with a current sensor, a determination of whether a sign of a current of each phase (in particular, U-phase and V-phase) is positive or negative cannot be made. Therefore, according to the first embodiment, the determination of whether the sign of the phase current is positive or negative is made based on the three-phase current command values iu*, iv*, and iw* calculated by the three-phase current command value calculator 31. That is, the sign of the dead-time correction value is determined based on the sign of the corresponding current command value.

Specifically, when the U-phase current command value iu* is positive, the U-phase dead-time correction value vu_dt is set to vu_dta, and when the U-phase current command value iu* is negative, the U-phase dead-time correction value vu_dt is set to −vu_dta. Likewise, when the V-phase current command value iv* is positive, the V-phase dead-time correction value vv_dt is set to vv_dta, and when the V-phase current command value iv* is negative, the V-phase dead-time correction value vv_dt is set to −vv_dta. Likewise, when the W-phase current command value iw* is positive, the W-phase dead-time correction value vw_dt is set to vw_dta, and when the W-phase current command value iw* is negative, the W-phase dead-time correction value vw_dt is set to −vw_dta.

Then, the U-phase, V-phase, and W-phase dead-time correction values vu_dt, vv_dt, and vw_dt are converted to the d-axis and q-axis dead-time correction values vd_dt and vq_dt by dq-transformation based on the electrical angle θe.

Then, the d-axis and q-axis dead-time correction values vd_dt and vq_dt are added to the d-axis and q-axis voltage command reference values vd_ref and vq_ref, respectively. In such an approach, a voltage necessary for the start-up of the AC motor 2 is ensured, so that the AC motor 2 can be started up from a state where the AC motor 2 remains stopped. Likewise, the AC motor 2 can be stopped from a state where the AC motor 2 is being driven.

In practice, an actual deadtime may deviate from the preset deadtime Tdt, and the machine constants used in the voltage equations may have an error. In view of these concerns, according to the first embodiment, a voltage amplitude correction is made in consideration of the deadtime deviation and the machine constant error.

According to the first embodiment, when the rotation speed N is low, in particular, when the rotation speed N is zero [rpm], a voltage amplitude is corrected based on the W-phase current command value iw* and the W-phase current detection value iw_sns by considering that a voltage and a current command are almost in phase.

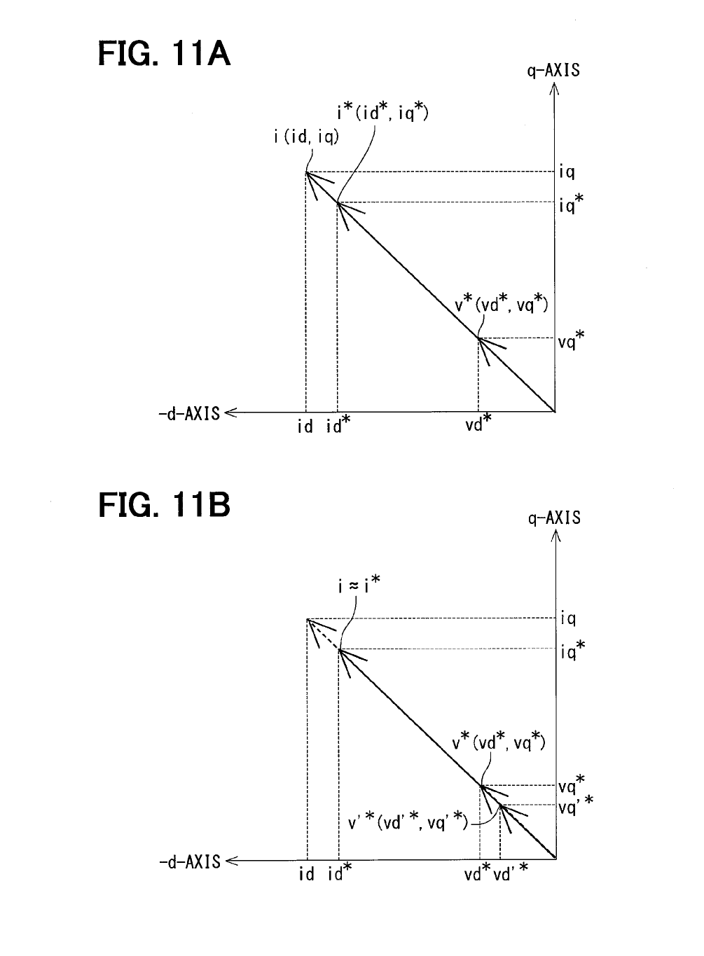

The voltage amplitude correction is described with reference to FIGS. 11A and 11B based on assumption that the rotation speed N is zero.

FIG. 11A shows a case where a current vector i(id, iq) of a current, which is actually energized when a voltage vector v(vd*, vq*) based on a current command vector i*(id*, iq*) is applied, is different from the current command vector i*(id*, iq*). In such a case, as shown in FIG. 11B, the actually energized current i(id, iq) can approach the current command vector i*(id*, iq*) by applying a voltage depending on a corrected voltage vector v′*(vd′*, vq′*) which is calculated by multiplying the voltage command vector v* by a ratio in amplitude between the current command vector i* and the actually energized current vector i.

As shown in FIG. 3, according to the first embodiment, the controller 15 includes the amplitude correction factor calculator 40. The amplitude correction factor calculator 40 calculates an amplitude correction factor Ka from the following formula (10). As can be seen from the following formula (10), the amplitude correction factor Ka is a ratio in amplitude between the W-phase current command value iw* and the W-phase current detection value iw_sns.

There is a possibility that “division by zero” or “multiplication by zero” may occur in the calculation of the amplitude correction factor K, so that accuracy of the calculation may be reduced. Therefore, it is preferable that interpolation of the amplitude correction factor Ka be made when the W-phase current command value iw* and the W-phase current detection value iw_sns are close to zero [A], i.e., when the W-phase current command value iw* and the W-phase current detection value iw_sns are within a predetermined range including zero. For example, according to the first embodiment, the interpolation is made by fixing the amplitude correction factor Ka to one. Alternatively, the interpolation can be made by using the last amplitude correction factor Ka. Alternatively, the interpolation can be made by setting upper and lower limits on the amplitude correction factor Ka so that the amplitude correction factor Ka can be within a predetermined range including a predetermined value, for example, one. That is, the incorporation method is not limited to a specific method.

The following formulas (11) and (12) represent second d-axis and q-axis voltage command interim values vd*_{—}2_int and vq*_{—}2_int, respectively. As can been seen from the formula (11), the second d-axis voltage command interim value vd*_{—}2_int is calculated by correcting the d-axis voltage command reference value vd_ref using the d-axis deadtime correction value vd_dt and the amplitude correction factor Ka. Likewise, as can been seen from the formula (12), the second q-axis voltage command interim value vq*_{—}2_int is calculated by correcting the q-axis voltage command reference value vq_ref using the q-axis deadtime correction value vq_dt and the amplitude correction factor Ka.

When the rotation speed N is not greater than the determination threshold A, the AC motor 2 is controlled by generating the PWM signals UU, UL, VU, VL, WU, and WL based on the second d-axis and q-axis voltage command interim values vd*_{—}2_int and vq*_{—}2_int. In such an approach, the AC motor 2 can be stably started up, from a state where the rotation speed N is zero, almost in accordance with the commands. Further, the AC motor 2 can be stably stopped up, from a state where the rotation speed N is equal to the determination threshold A, almost in accordance with the commands. Thus, the AC motor 2 can be suitably started up, driven, and stopped.

There is a possibility that the second d-axis and q-axis voltage command interim values vd*_{—}2_int and vq*_{—}2_int and/or the d-axis and q-axis voltage command values vd* and vq* calculated in the two-phase control mode may fluctuate almost periodically due to a structure of the AC motor 2 such as a layout of a slot where a coil is wound or due to the sign switching of the deadtime.

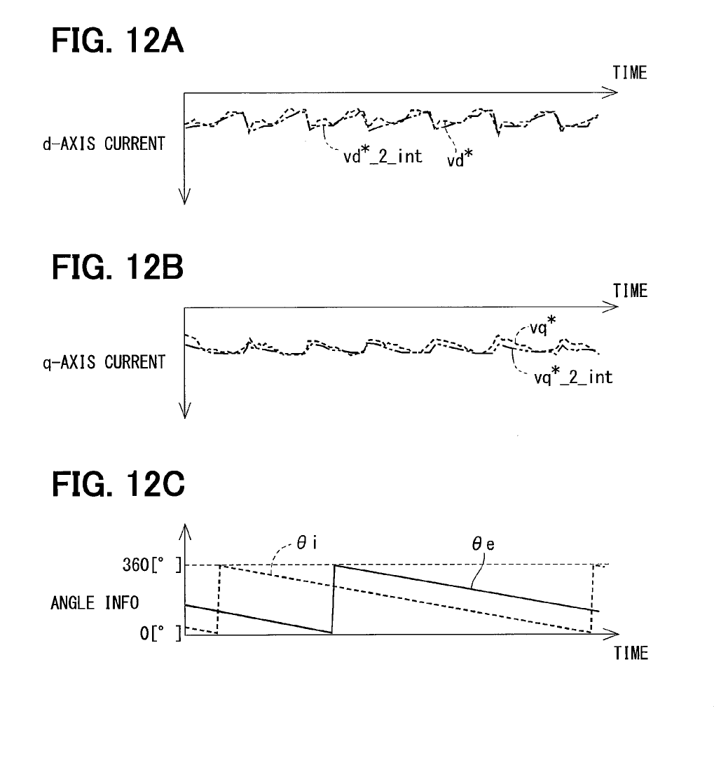

FIGS. 12A-12C show an example where although the second d-axis and q-axis voltage command interim values vd*_{—}2_int and vq*_{—}2_int are calculated, the AC motor 2 is controlled based on the d-axis and q-axis voltage command values vd* and vq* calculated in the two-phase control mode. As shown in FIG. 12, the second d-axis and q-axis voltage command interim values vd*_{—}2_int and vq*_{—}2_int indicated by a chain double-dashed line fluctuate in the sixth order in one period of a phase angle θi (or the electrical angle θe) of the current command vector i. Although the d-axis and q-axis voltage command values vd* and vq* indicated by a broken line fluctuate almost in the same manner as the second d-axis and q-axis voltage command interim values vd*_{—}2_int and vq*_{—}2_int, there is a little difference between them. If the second d-axis and q-axis voltage command interim values vd*_{—}2_int and vq*_{—}2_int are actually applied, the difference may cause fluctuations in actual torque value trq with reference to torque accuracy in the two-phase control mode.

As mentioned previously, the AC motor 2 is connected to the drive wheel 6 through the gear 4 (refer to FIG. 1). Therefore, in the example shown in FIGS. 12A-12C, when the vehicle moves forward, i.e., when the drive wheel 6 rotates in a forward direction, the AC motor 2 rerates in a reverse direction. Further, when the vehicle moves forward, i.e., when the drive wheel 6 is caused to rotate in a forward direction to cause the vehicle to move forward, the AC motor 2 outputs negative torque. Accordingly, when the vehicle moves forward, each of the torque and the q-axis current have a negative value. It is noted that the d-axis current always has a negative value regardless of the torque and the rotation speed.

Therefore, according to the first embodiment, the voltage correction factor calculator 52 calculates the d-axis and q-axis voltage correction factors Kd and Kq according to the phase angle θi to correct the d-axis and q-axis voltage command reference values vd_ref and vq_ref so that the actual torque value trq can follow the torque command value trq*. Specifically, according to the first embodiment, as shown in FIG. 13, a first mapping table defining a relationship between the phase angle θi and the d-axis and q-axis voltage correction factors Kd and Kq is stored in a memory section (not shown) of the controller 15. The voltage correction factor calculator 52 calculates the d-axis and q-axis voltage correction factors Kd and Kq from the first mapping table based on the phase angle θi as a variable. The d-axis and q-axis voltage correction factors Kd and Kq correspond to actual behavior information related to an actual behavior of an AC motor recited in claims.

As can be seen from the following formulas (13) and (14), the voltage command reference value corrector 23 calculates the second d-axis and q-axis voltage command values vd*_{—}2 and vq*_{—}2 by correcting the d-axis and q-axis voltage command reference values vd_ref and vq_ref based on the d-axis and q-axis voltage correction factors Kd and Kq in addition to the d-axis and q-axis deadtime correction values vd_dt and vq_dt and the amplitude correction factor Ka.

vd*_{—}2=Kd×Ka×(vd_ref+vd_{—}dt) (13)

vq*_{—}2=Kq×Ka×(vq_ref+vq_{—}dt) (14)

The d-axis voltage correction factor Kd is a factor used to correct the value “Ka×(vd_ref+vd_dt)”, which is calculated by correcting the d-axis voltage command reference value vd_ref using the d-axis deadtime correction value vd_dt and the amplitude correction factor Ka so that torque equal to the torque command value trq* can be outputted. Likewise, the q-axis voltage correction factor Kq is a factor used to correct the value “Ka×(vq_ref+vq_dt)”, which is calculated by correcting the q-axis voltage command reference value vq_ref using the q-axis deadtime correction value vq_dt and the amplitude correction factor Ka so that torque equal to the torque command value trq* can be outputted.

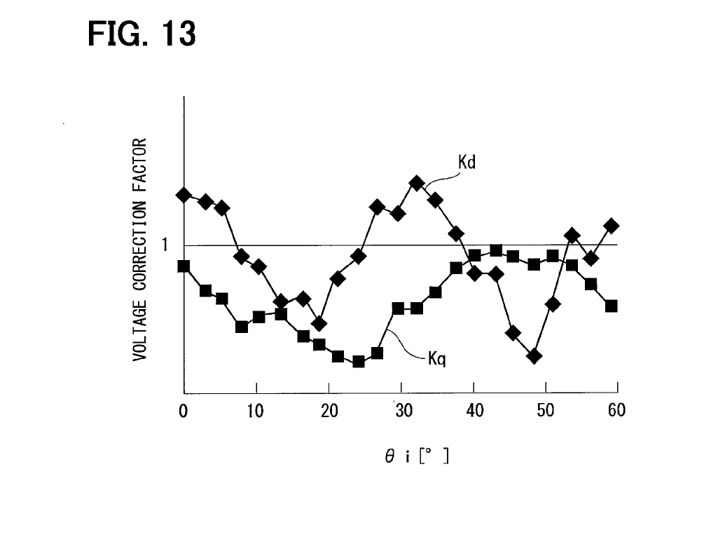

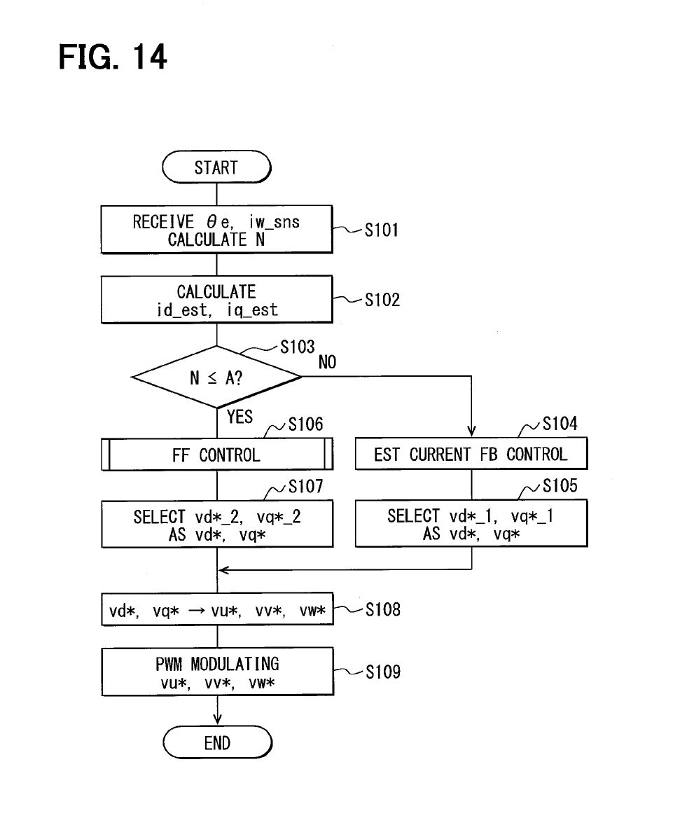

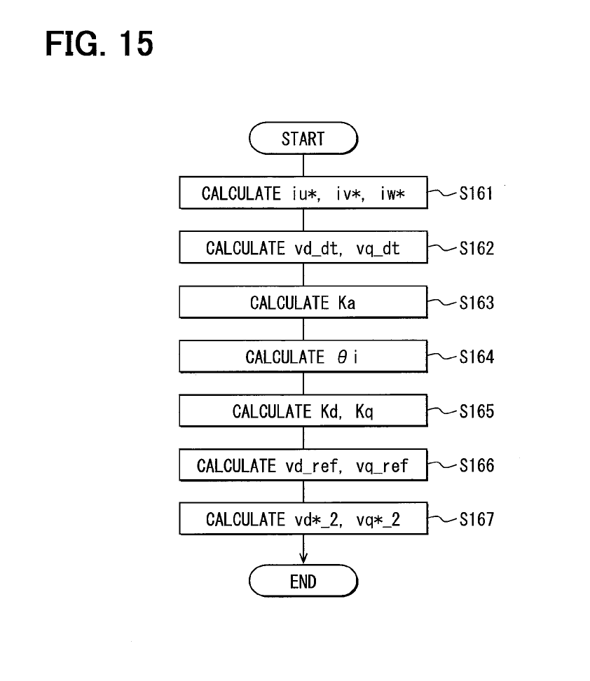

Next, a drive control process for driving the AC motor 2 according to the first embodiment is described with reference to a flowchart shown in FIG. 14. The drive control process is performed by the controller 15. FIG. 15 is a flowchart of a FF control procedure included in the drive control process. As shown in FIG. 14, the drive control process starts at S101 where the controller 15 receives the electrical angle θe from the rotation angle sensor 14 and calculates the rotation speed N. Further, at S101, the controller 15 receives the W-phase current detection value iw_sns from the current sensor 13.

Then, at S102, the current estimator 24 calculates the d-axis and q-axis current estimation values id_est and iq_est based on the W-phase current detection value iw_sns and the electrical angle θe. According to the first embodiment, the d-axis and q-axis current estimation values id_est and iq_est are calculated based on the d-axis and q-axis current command values id* and iq* in addition to the W-phase current detection value iw_sns and the electrical angle θe. Thus, according to the first embodiment, the d-axis and q-axis current estimation values id_est and iq_est are always calculated regardless of the rotation speed N.

Then, at S103, it is determined whether the rotation speed N is not greater than the determination threshold A. If it is determined that the rotation speed N is not greater than the determination threshold A corresponding to YES at S103, the drive control process proceeds to S106. In contrast, if it is determined that the rotation speed N is greater than the determination threshold A corresponding to NO at S103, the drive control process proceeds to S104.

At S104, the drive mode is switched to the estimation current FB control mode, and the voltage command value calculator 25 calculates the first d-axis and q-axis voltage command values vd*_{—}1 and vq*_{—}1 based on the d-axis and q-axis current command values id* and iq* and the d-axis and q-axis current estimation values id_est and iq_est. In this case, if an affirmative determination was made at S103 in the last drive control process, i.e., if the last control mode was the FF control mode, it is preferable that the last d-axis and q-axis voltage command values vd* and vq* be set as initial values of the PI integral term in the PI calculation. In such an approach, sudden changes in the d-axis and q-axis voltage command values vd* and vq* occurring when the control mode is switched from the FF control mode to the estimation current FB mode can be reduced or prevented.

At S105, the first d-axis and q-axis voltage command values vd*_{—}1 and vq*_{—}1 are selected as the d-axis and q-axis voltage command values vd* and vq*, respectively.

At S106, to which the drive control process proceeds if it is determined that the rotation speed N is not greater than the determination threshold A corresponding to YES at S103, the drive mode is set to the FF control mode instead of the estimation current FB control mode so that the FF control procedure shown in FIG. 15 can be performed.

As shown in FIG. 15, the FF control procedure starts at S161 where the three-phase current command value calculator 31 calculates the three-phase current command values iu*, iv*, and iw* based on the d-axis and q-axis current command values id* and iq* and the electrical angle 8e.

At S162, the dead-time correction value calculator 32 calculates the d-axis and q-axis dead-time correction values vd_dt and vq_dt.

At S163, the amplitude correction factor calculator 40 calculates the amplitude correction factor Ka.

At S164, the phase calculator 51 calculates the phase angle θi of the current command vector i* with respect to the U-phase axis.

At S165, the voltage correction factor calculator 52 calculates the d-axis and q-axis voltage correction factors Kd and Kq based on the phase angle θi. According to the first embodiment, the d-axis and q-axis voltage correction factors Kd and Kq are calculated by referring to a mapping table that uses the phase angle θi as a parameter.

At S166, the voltage command reference value calculator 22 calculates the d-axis and q-axis voltage command reference values vd_ref and vq_ref based on the d-axis and q-axis current command values id* and iq* using the voltage equations.

At S167, the voltage command reference value corrector 23 calculates the second d-axis and q-axis voltage command values vd*_{—}2 and vq*_{—}2 by correcting the d-axis and q-axis voltage command reference values vd_ref and vq_ref based on the d-axis and q-axis dead-time correction values vd_dt and vq_dt, the amplitude correction factor Ka, and the d-axis and q-axis voltage correction factors Kd and Kq (refer to the formulas (13) and (14)).

Returning to FIG. 11, at S106 subsequent to S107, the second d-axis and q-axis voltage command values vd*_{—}2 and vq*_{—}2 are selected as the d-axis and q-axis voltage command values vd* and vq*, respectively.

At S108, the three-phase voltage command value calculator 27 calculates the three-phase voltage command value vu*, vv*, and vw* by performing inverse dq transformation of the d-axis and q-axis voltage command values vd* and vq* based on the electrical angle θe.

At S109, the PWM signal generator 28 calculates the PWM signals UU, UL, VU, VL, WU, and WL by PWM-modulating the three-phase voltage command values vu*, vv*, and vw* based on the inverter input voltage VH and outputs the PWM signals UU, UL, VU, VL, WU, and WL to the inverter 12.

The switching devices of the inverter 12 are turned ON and OFF based on the PWN signals UU, UL, VU, VL, WU, and WL so that the three-phase AC voltages vu, vv, and vw can be generated. The three-phase AC voltages vu, vv, and vw are applied to the AC motor 2 so that the AC motor 2 can output torque corresponding to the torque command value trq*.

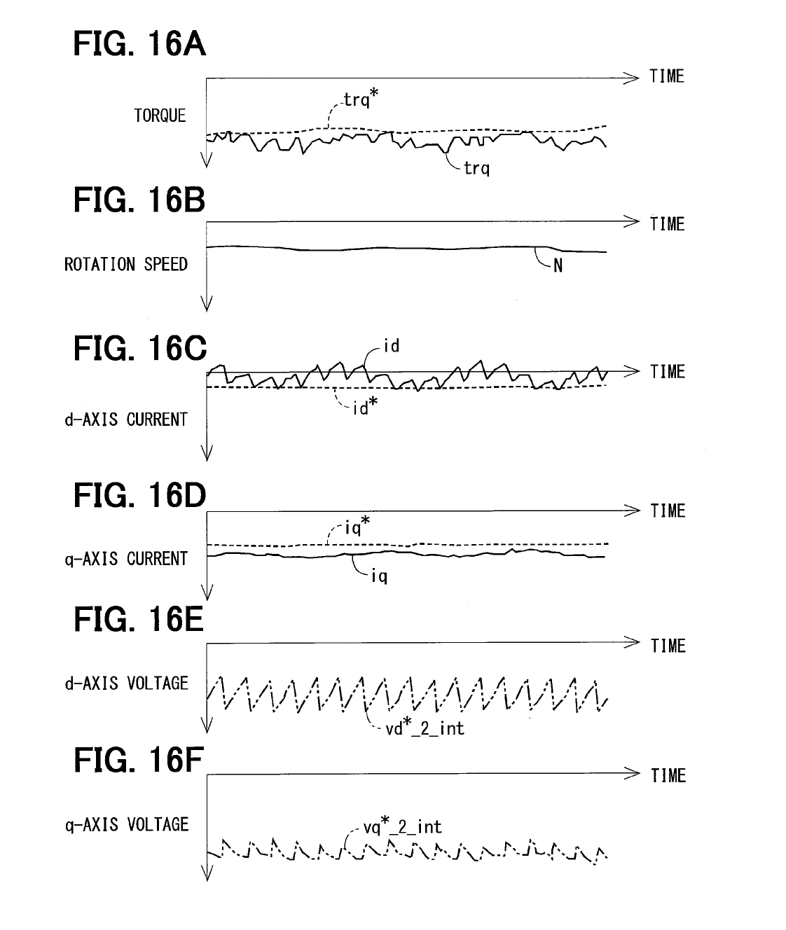

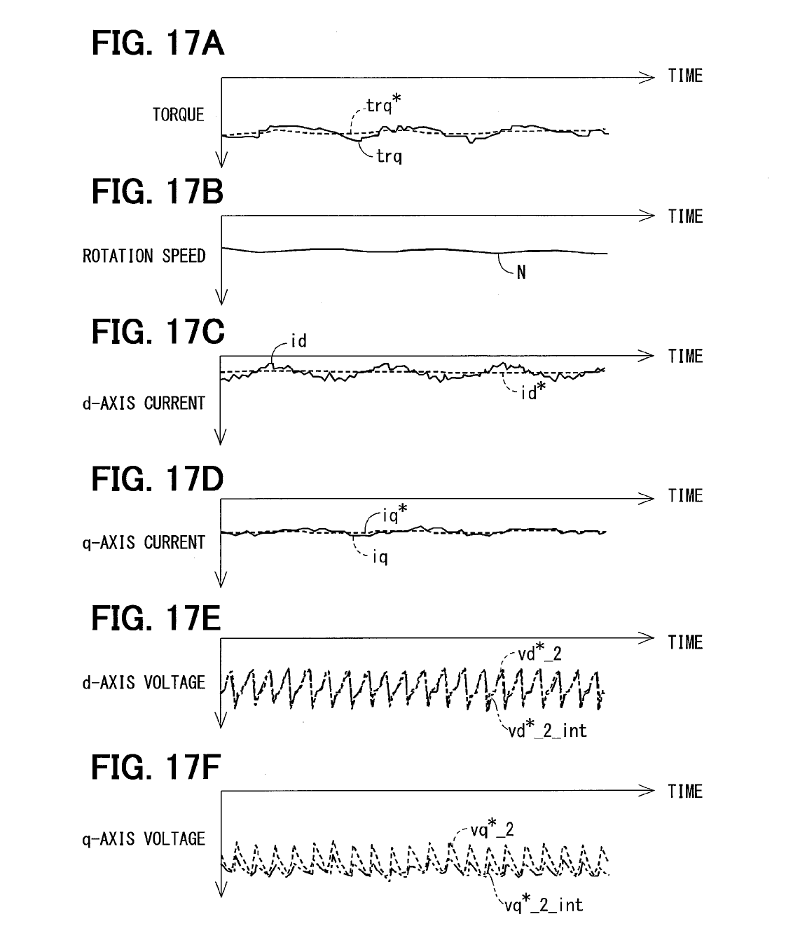

FIGS. 16A, 16B, 16C, 16D, 16E, and 16F are timing diagrams for explaining a behavior of the AC motor 2 according to a reference example. In the reference example, when the rotation speed N is not greater than the determination threshold A, the AC motor 2 is controlled based on the second d-axis and q-axis voltage command interim values vd*_{—}2_int and vq*_{—}2_int, which are not corrected using the d-axis and q-axis voltage correction factors Kd and Kq. FIGS. 17A, 17B, 17C, 17D, 17E, and 17F are timing diagrams for explaining a behavior of the AC motor 2 according to the first embodiment. In the first embodiment, when the rotation speed N is not greater than the determination threshold A, the AC motor 2 is controlled based on the second d-axis and q-axis voltage command values vd*_{—}2 and vq*_{—}2, which are calculated by correcting the second d-axis and q-axis voltage command interim values vd*_{—}2_int and vq*_{—}2_int using the d-axis and q-axis voltage correction factors Kd and Kq.

FIGS. 16A and 17A represent torque. FIGS. 16B and 17B represent a rotation speed. FIGS. 16C and 17C represent a q-axis current. FIGS. 16D and 17D represent a d-axis current. FIGS. 16E and 17E represent a q-axis voltage. FIGS. 16F and 17F represent a q-axis current. In FIGS. 16A, 16C, 16D, 17A, 17C, and 17D, a solid line represents an actual value, and a broken line represents a command value. In FIGS. 16E and 16F, a chain double-dashed line represents the second d-axis and q-axis voltage command interim values vd*_{—}2_int and vq*_{—}2_int, and a broken line represents the second d-axis and q-axis voltage command values vd*_{—}2 and vq*_{—}2. The torque and the rotation speed direction are the same as those of FIG. 12.

As shown in FIGS. 16C and 16D, according to the reference example, when the three-phase AC voltages vu, vv, and vw generated based on the second d-axis and q-axis voltage command interim values vd*_{—}2_int and vq*_{—}2_int are applied to the AC motor 2, the d-axis current actual value id deviates slightly from the d-axis current command value id*, and the q-axis current actual value iq deviates slightly from the q-axis current command value iq*. Accordingly, although the actual torque value trq almost follows the torque command value trq*, the actual torque value trq fluctuates periodically.

In contrast, as shown in FIGS. 17C and 17D, according to the reference example, when the three-phase AC voltages vu, vv, and vw generated based on the second d-axis and q-axis voltage command values vd*_{—}2 and vq*_{—}2 are applied to the AC motor 2, the deviation between the d-axis current actual value id and the d-axis current command value id* is reduced, and the deviation between the q-axis current actual value iq and the q-axis current command value iq* is reduced. Accordingly, the deviation between the actual torque value trq and the torque command value trq* is reduced. Further, since small fluctuations in the actual torque value trq in one period of the phase angle θi, in particular, due to a physical or magnetic structure of the AC motor 2 such as a layout of the slot or due to the sign switching of the deadtime is reduced, driveability in a motor-operated vehicle such as a hybrid vehicle or an electric vehicle can be improved.

As described above, according to the first embodiment, the motor control apparatus 10 controls the three-phase AC motor 2 to which the voltages vu, vv, and vw controlled by the inverter 12 is applied.

The procedures performed in the controller 15 of the motor control apparatus 10 can be summarized as follows. The current detection value iw_sns is received from the current sensor 13 which is provided to any one of the phases (e.g., W-phase in the first embodiment) of the AC motor 2 (at S101 in FIG. 14). Further, the electrical angle θe is received from the rotation angle sensor 14 (at S101) which detects a rotation angle of the AC motor 2. The rotation speed calculator 16 calculates the rotation speed N of the AC motor 2 based on the electrical angle θe (at S101).

The current estimator 24 calculates the d-axis and q-axis current estimation values id_est and iq_est based on the W-phase current detection value iw_sns and the electrical angle θe (at S102). According to the first embodiment, the d-axis and q-axis current estimation values id_est and iq_est are calculated based on the d-axis and q-axis current command values id* and iq* in addition to the W-phase current detection value iw_sns and the electrical angle θe. The voltage command value calculator 25 calculates the first d-axis and q-axis voltage command values vd*_{—}1 and vq*_{—}1 based on the d-axis and q-axis current command values id* and iq*, which are related to driving of the AC motor 2, and the feedback d-axis and q-axis current estimation values id_est and iq_est (at S104).

The voltage command reference value corrector 23 calculates the second d-axis and q-axis voltage command values vd*_{—}2 and vq*_{—}2 based on the d-axis and q-axis voltage correction factors Kd and Kq, which are actual behavior information related to an actual behavior of the AC motor 2 according to the phase angle θi of the current command vector i* (at S167 in FIG. 15). Specifically, according to the first embodiment, the d-axis and q-axis voltage correction factors Kd and Kq as the actual behavior information are used to correct the d-axis and q-axis voltage command reference values vd_ref and vq_ref, which are calculated from the voltage equations based on the d-axis and q-axis current command values id* and iq*. The voltage command reference value corrector 23 calculates the second d-axis and q-axis voltage command values vd*_{—}2 and vq*_{—}2 by correcting the d-axis and q-axis voltage command reference values vd_ref and vq_ref using the d-axis and q-axis voltage correction factors Kd and Kq.

If the rotation speed N is greater than the determination threshold A (NO at S103), the drive mode is switched to the estimation current FB control mode, where the PWM signals UU, UL, VU, VL, WU, and WL, which are related to driving of the inverter 12, are generated based on the first d-axis and q-axis voltage command values vd*_{—}1 and vq*_{—}1. In contrast, if the rotation speed N is not greater than the determination threshold A (YES at S103), the drive mode is switched to the FF control mode, where the PWM signals UU, UL, VU, VL, WU, and WL are generated based on the second d-axis and q-axis voltage command values vd*_{—}2 and vq*_{—}2. Specifically, when the rotation speed N is greater than the determination threshold A (NO at S103), the first d-axis and q-axis voltage command values vd*_{—}1 and vq*_{—}1 are selected as the d-axis and q-axis voltage command values vd* and vq* (at S105). In contrast, when the rotation speed N is not greater than the determination threshold A (YES at S103), the second d-axis and q-axis voltage command values vd*_{—}2 and vq*_{—}2 are selected as the d-axis and q-axis voltage command values vd* and vq* (at S107).

According to the first embodiment, the current sensor 13 is provided to the W-phase, and no current sensor is provided to the U-phase and the W-phase. Thus, the number of current sensors used in the motor control apparatus 10 is reduced. Accordingly, the size of the inverter 12 near its output terminals is reduced, and the cost of the motor control apparatus 10 is reduced.

In the estimation current FB control mode, where the AC motor 2 is controlled based on the feedback d-axis and q-axis current estimation values id_est and iq_est estimated using the current detection value iw_sns of one phase (e.g., W-phase in the first embodiment), when the rotation speed N is low, the electrical angle change Δθe and the current change Δiw in the sampling interval Ts become small. As a result, the control of the AC motor 2 may become unstable, so that torque may not be accurately outputted.

In view of the above, according to the first embodiment, when the rotation speed N is not greater than the determination threshold A, the FF control mode is used instead of the estimation current FB control mode so that the second d-axis and q-axis voltage command values vd*_{—}2 and vq*_{—}2 can be calculated by using the actual behavior information according to the phase angle θi of the current command vector i*. Specifically, according to the first embodiment, the actual behavior information includes the d-axis and q-axis voltage correction factors Kd and Kq used to correct the d-axis and q-axis voltage command reference values vd_ref and vq_ref. Thus, the second d-axis and q-axis voltage command values vd*_{—}2 and vq*_{—}2 are calculated by taking into account the d-axis and q-axis voltage correction factors Kd and Kq. Therefore, the AC motor 2 can be stably controlled even when the rotation speed N is low. Further, since the second d-axis and q-axis voltage command values vd*_{—}2 and vq*_{—}2 are calculated by using the d-axis and q-axis voltage correction factors Kd and Kq, fluctuations in actual torque value trq outputted from the AC motor 2 are reduced. Accordingly, when the motor drive system 1 is used for a motor-operated vehicle such as a hybrid vehicle or an electric vehicle, a reduction in driveability due to a low rotation speed of the AC motor 2 can be prevented.

Correspondence between terms used in the first embodiment and claims is as follows. The controller 15 corresponds to a current receiver, a rotation angle receiver, a rotation speed calculator, a current estimator, a first voltage command value calculator, a voltage command reference value calculator, a second voltage command value calculator, and a control mode switch. Specifically, the current estimator 24 corresponds to a current estimator, the voltage command value calculator 25 corresponds to a first voltage command value calculator, the voltage command reference value corrector 23 corresponds to a second voltage command value calculator, and the switch determinator 26 corresponds to a control mode switch.

S101 in FIG. 14 corresponds to a procedure as functions of a current receiver, a rotation angle receiver, and a rotation speed calculator. S102 corresponds to a procedure as a current estimator. S104 corresponds to a procedure as a function of a first voltage command value calculator. S167 in FIG. 15 corresponds to a procedure as a function of a second voltage command value calculator. S105 and S107 in FIG. 14 correspond to procedures as a function of a control mode switch.

The W-phase corresponds to a sensor-phase. The W-phase current detection value iw_sns corresponds to a current detection value. The electrical angle θe corresponds to a rotation angle detection value. The d-axis and q-axis current estimation values id_est and iq_est correspond to a current estimation value. The d-axis and q-axis current command values id* and iq* correspond to a current command value. The first d-axis and q-axis voltage command values vd*_{—}1 and vq*_{—}1 correspond to a first voltage command value. The d-axis and q-axis voltage command reference values vd_ref and vq_ref correspond to a voltage command reference value. The second d-axis and q-axis voltage command values vd*_{—}2 and vq*_{—}2 correspond to a second voltage command value.

The d-axis and q-axis voltage correction factors Kd and Kq correspond to actual behavior information and a voltage correction value. The PWM signals UU, UL, VU, VL, WU, and WL correspond to a drive signal.

### Second Embodiment

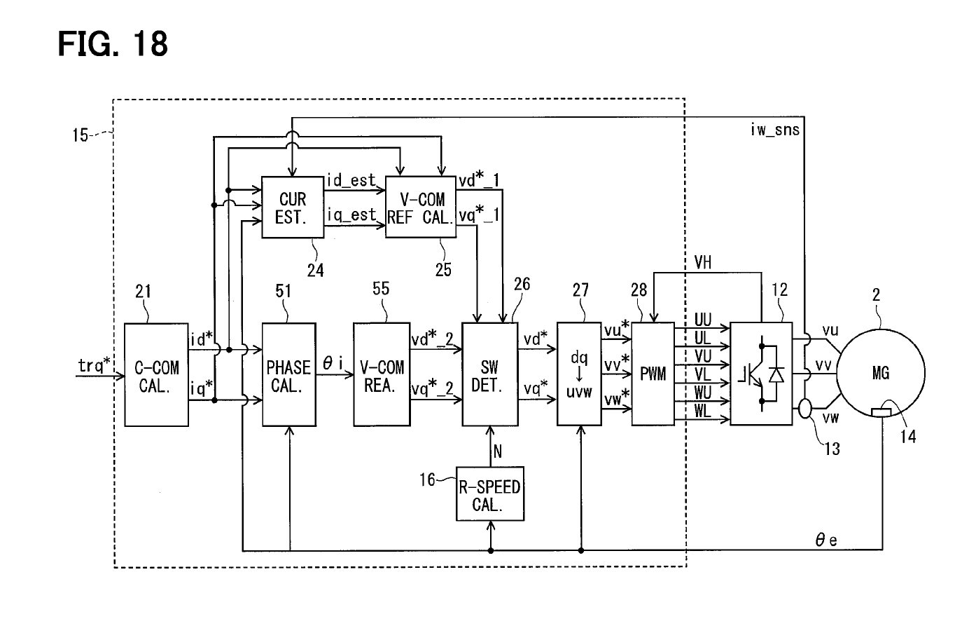

A second embodiment of the present disclosure is described below with reverence to FIGS. 18-20. Differences between the first and second embodiments are as follows.

In the first embodiment, the first mapping table, which defines a relationship between the phase angle θi and the d-axis and q-axis voltage correction factors Kd and Kq to correct the d-axis and q-axis voltage command reference values vd_ref and vq_ref so that the actual torque value trq equal to the torque command value trq* can be outputted, is created and stored in a memory section (not shown) of the controller 15. In contrast, in the second embodiment, instead of the first mapping table, a second mapping table defining a relationship between the phase angle θi and the second d-axis and q-axis voltage command values vd*_{—}2 and vq*_{—}2 is created and stored in the memory section of the controller 15. For example, the d-axis and q-axis current actual values vd and vq shown in FIG. 12 can be mapped as the second d-axis and q-axis voltage command values vd*_{—}2 and vq*_{—}2 in the second mapping table. That is, according to the second embodiment, the second d-axis and q-axis voltage command values vd*_{—}2 and vq*_{—}2 themselves correspond to actual behavior information related to an actual behavior of the AC motor recited in claims.

FIG. 18 shows a controller 15 according to the second embodiment. As can be seen from FIG. 18, the controller 15 has a voltage command value reader 55 between the phase calculator 51 and the switch determinator 26. Instead, according to the second embodiment, the voltage command reference value calculator 22, the voltage command reference value corrector 23, the three-phase current command value calculator 31, the dead-time correction value calculator 32, and the amplitude correction factor calculator 40 are eliminated from the controller 15.

The voltage command value reader 55 calculates the second d-axis and q-axis voltage command values vd*_{—}2 and vq*_{—}2 from the second mapping table based on the phase angle θi.

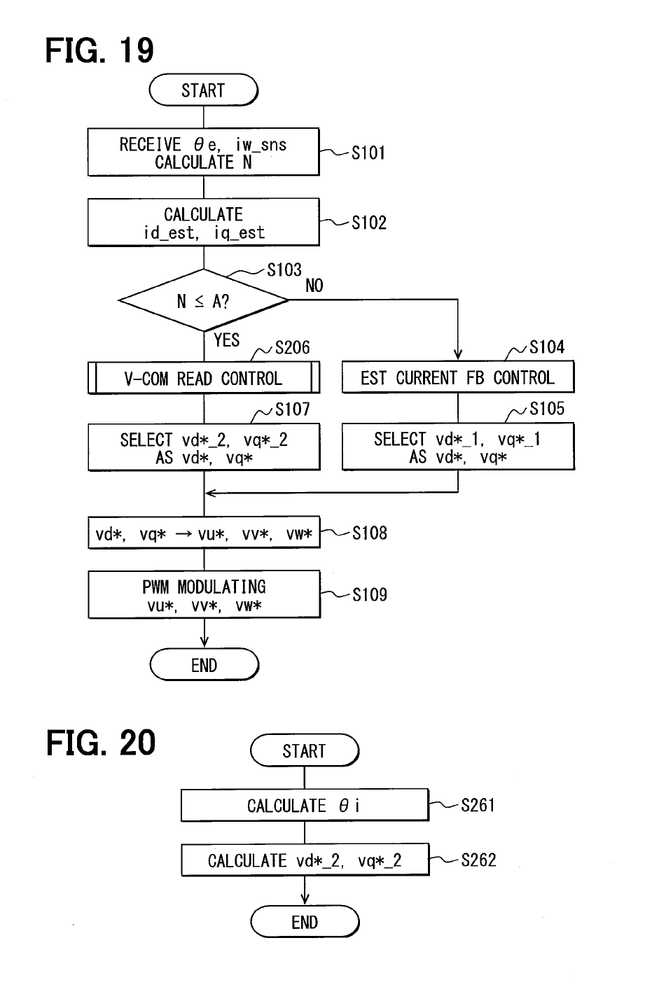

Next, a drive control process for driving the AC motor 2 according to the second embodiment is described with reference to a flowchart shown in FIG. 19. The drive control process is performed by the controller 15. FIG. 20 is a flowchart of a voltage command value read procedure included in the drive control process.

A difference between FIGS. 14 and 19 is that S106 where the FF control procedure is performed is replaced with S206 where the voltage command value read procedure is performed.

At S106, to which the drive control process proceeds if it is determined that the rotation speed N is not greater than the determination threshold A corresponding to YES at S103, the drive mode is set to a voltage command value read control mode instead of the estimation current FB control mode so the voltage command value read procedure shown in FIG. 20 can be performed.

As shown in FIG. 20, the voltage command value read procedure starts at S261 where the phase calculator 51 calculates the phase angle θi of the current command vector i* with respect to the U-phase axis like at S164 in FIG. 15.

Then, at S262, the voltage command value reader 55 calculates the second d-axis and q-axis voltage command values vd*_{—}2 and vq*_{—}2 based on the phase angle θi. According to the second embodiment, the voltage command value reader 55 calculates the second d-axis and q-axis voltage command values vd*_{—}2 and vq*_{—}2 from the second mapping table based on the phase angle θi as a parameter.

Returning to FIG. 19, at S107 subsequent to S206, the second d-axis and q-axis voltage command values vd*_{—}2 and vq*_{—}2 are selected as the d-axis and q-axis voltage command values vd* and vq*, respectively, like at S107 in FIG. 14.

As described above, according to the second embodiment, the second d-axis and q-axis voltage command values vd*_{—}2 and vq*_{—}2 themselves are used as the actual behavior information, and the voltage command value reader 55 calculates the second d-axis and q-axis voltage command values vd*_{—}2 and vq*_{—}2 from the second mapping table based on the phase angle θi of the current command vector i*. Thus, the second d-axis and q-axis voltage command values vd*_{—}2 and vq*_{—}2 can be easily calculated.

Correspondence between terms used in the second embodiment and claims is as follows.

The voltage command value reader 55 corresponds to a second voltage command value calculator. S262 in FIG. 20 corresponds to a procedure as a function of a second voltage command value calculator. The voltage command value read control mode corresponds to a second control mode.

(Modifications)

The above embodiments can be modified in various ways, for example, as follows.

(1) In the first embodiment, the voltage command reference value is calculated from the voltage equation as a theoretical formula for a motor. Alternatively, the voltage command reference value can be calculated by any other method such as by referring to a prestored mapping table, as long as the voltage command reference value is calculated based on the current command value. Alternatively, the voltage command reference value can be calculated based on a value, depending on the current command value, such as the torque command value or the rotation speed.

(2) In the first embodiment, the second voltage command value is calculated by correcting the voltage command reference value, which is calculated from a theoretical formula for a motor, based on the deadtime correction value and the amplitude correction factor. Alternatively, the voltage command correction value can be any other value than a value depending on the deadtime correction value, as long as the voltage command correction value corresponds to a difference between a theoretical voltage command reference value and a voltage command value necessary for the motor to actually output torque corresponding to the torque command value. That is, the voltage command reference value can be corrected based on any value.

The deadtime correction value can be calculated by any other method than that described in the embodiments. For example, the deadtime correction value v_dt on the dq coordinate system can be distributed between the d-axis and the q-axis according to the magnitude of the d-axis and q-axis current command values id* and iq*.

In the first embodiment, when the deadtime correction value is calculated, the determination of whether the sign of the phase current is positive or negative is made based on the three-phase current command value. Alternatively, the determination of whether the sign of the phase current of the sensor phase is positive or negative can be made based on the current detection value. That is, the sign of the deadtime correction value can be determined based on the sign of the current command value or the current detection value.

When the current command value of each phase is zero or within a predetermined range including zero, the deadtime correction value can be set to zero. Further, to prevent the deadtime correction value from sharply changing when a zero-crossing of the current command value of each phase occurs, a smoothing process such as a low-pass filtering process can be performed as necessary. The instant predetermined range can be equal to or different from the predetermined range related to the interpolation of the amplitude correction factor.

In the first embodiment, the voltage command reference value is corrected based on the ratio between the current command value and the current detection value. Alternatively, the voltage command reference value can be corrected by any other method, as long as the voltage command reference value is corrected based on the current command value and the current detection value. Further, it is not always necessary that the voltage command reference value is corrected based on the current command value, the current detection value, the deadtime correction value, or the like. For example, the second voltage command value can be calculated by correcting the voltage command reference value based on actual behavior information such as the voltage correction value.

The voltage correction value as the actual behavior information is used to correct a target voltage command value to be corrected (including the voltage command reference value to which other corrections such as the deadtime correction has been applied) so that the actual torque value trq can correspond to the torque command value trq*. Therefore, the correction value corresponding to the target voltage command value is stored in the mapping table. The same is true for when multiple mapping tables are stored according to the magnitudes of the torque command value as described later in (5).

When the current detection value is within a predetermined range including zero, the amplitude correction factor can be fixed to a value other than one. Alternatively, the amplitude correction factor cannot be fixed to a specific value. Alternatively, the interpolation can be made by continuing a calculation such as a filter process. It is not always necessary that the upper and lower limits are set on the amplitude correction factor.

(3) In the first embodiment, the d-axis and q-axis correction factors are used as the voltage correction value. Alternatively, the voltage correction value can be different from the d-axis and q-axis correction factors, as long as the voltage correction value can correct the voltage command reference value. The voltage command reference value can be corrected by calculation processes other than multiplication and division using the voltage correction value. For example, the voltage command reference value can be corrected by addition and/or subtraction using the voltage correction value.

(4) In the first embodiment, the voltage correction value is calculated from the first mapping table based on the phase angle of the current command vector. In the second embodiment, the second voltage command value is calculated directly from the second mapping table based on the phase angle of the current command vector. Alternatively, the voltage correction value or the second voltage command value can be calculated based on the electrical angle instead of the phase angle of the current command vector. When the deadtime correction is made as described in the embodiments, the actual deadtime may lead or change depending on the current phase with respect to the voltage. Therefore, it is preferable that the voltage correction value should be corrected based on the phase angle.

(5) Multiple first mapping tables related to the voltage correction value or multiple second mapping tables related to the second voltage command value can be stored according to the magnitudes of the torque command value. That is, the actual behavior information can be a value depending on the torque command value and either the rotation angle detection value or the phase angle of the current command vector, the voltage correction value can be calculated based on the torque command value and either the rotation angle detection value or the phase angle of the current command vector, and the second voltage command value can be calculated based on the torque command value and either the rotation angle detection value or the phase angle of the current command vector.

The actual behavior information is not limited to the voltage correction value used to correct the voltage command reference value or the second voltage command value itself.

Further, when multiple current commands are included, for example, by moving the current command vector on equally-spaced torque lines, it is preferable that a correction mapping table related to the actual behavior information be provided for each command.

(6) The determination threshold of the rotation speed based on which the control mode switches between the estimation current FB mode and either the FF control mode or the voltage command value read control mode can be set according to, for example, a calculation accuracy in the estimation current FB mode. In the embodiments, one determination threshold is used to switch the control mode between the estimation current FB mode and either the FF control mode or the voltage command value read control mode. Alternatively, in order to prevent hunting from occurring due to the control mode switching between the estimation current FB mode and either the FF control mode or the voltage command value read control mode, the determination threshold can be different between when the rotation speed increases and when the rotation speed decreases. That is, the determination threshold can have hysteresis. In this case, although it is preferable that a determination threshold Au used when the rotation speed increases be greater than a determination threshold Ad used when the rotation speed decreases, the determination threshold Au can be smaller than the determination threshold Ad.

In the embodiments, the current estimator calculates the d-axis and q-axis current estimation values by considering the current command values of the phases, other than the sensor-phase, as the estimation values.

The current estimator can calculate the d-axis and q-axis current estimation values by any other method than that described in the embodiments, as long as the d-axis and q-axis current estimation values are calculated based on the current detection value and the electrical angle. Further, the d-axis and q-axis current estimation values can be calculated based on another parameter in addition to the current detection value and the electrical angle. The first voltage command value can be calculated by any other method than that described in the embodiments, as long as the first voltage command value is calculated based on the current command value and the feedback current estimation values. Further, the first voltage command value can be calculated based on another parameter in addition to the current command value and the feedback current estimation values.

In the embodiments, the d-axis and q-axis current estimation values and the first d-axis and q-axis voltage command values are always calculated regardless of the rotation speed. Alternatively, the d-axis and q-axis current estimation values and the first d-axis and q-axis voltage command values can be calculated only when the rotation speed is greater than the determination threshold. In other words, there can be no need to calculate the d-axis and q-axis current estimation values and the first d-axis and q-axis voltage command values when the rotation speed is not greater than the determination threshold.

For example, the current estimator can employ any of the following current estimation methods (i), (ii), (iii), and (iv) instead of the method disclosed in the embodiments. Here, a U-phase is defined as a sensor-phase.

(i) Estimation Based on a Current Reference Angle, which is Based on a Current Command Phase Angle, and a Current Amplitude.

For example, as disclosed in JP-A-2004-159391, a current amplitude (Ia) is calculated by dividing a current detection value (Iu) of the sensor-phase by a U-phase current reference angle (θ′) which is calculated from an electrical angle and a current command phase angle which is calculated from d-axis and q-axis current command values. Then, the other two phase current estimations values iv, iw are calculated by multiplying the current amplitude by sine values of electrical angles shifted by ±120° with respect to U-phase current reference angle (refer to formulas (15.1), (15.2), and (15.3)).

Ia=Iu/[√(⅓)×{−sin(0)}] (15.1)

Iv=√(⅓)×Ia×{−sin(θ′+120°)} (15.2)

Iw=√(⅓)×Ia×{−sin(θ′+240°)} (15.3)

(ii) Estimation Based on a Sensor-Phase Reference Phase Using a Current Command Value

A α-axis current is in a α-axis direction coinciding with a sensor-phase and a β-axis current in a β-axis direction perpendicular to the sensor-phase are calculated based on a W-phase current detection value iw_sns, an electrical angle θe, and at least one of a U-phase current command value iu* and a V-phase current command value iv*. Then, a sensor-phase reference current phase θx is calculated from the following formula (16).

θx=tan⁻¹(iβ/iα) (16)

Then, one of a U-phase current estimation value iu_est and a V-phase current estimation value iv_est is calculated based on the sensor-phase reference current phase θx and the W-phase current detection value iw_sns. Then, d-axis and q-axis current estimation values id_est and iq_est are calculated based on the W-phase current detection value iw_sns, the electrical angle θe, and the one of the U-phase current estimation value iu_est and the V-phase current estimation value iv_est.

When the one of the U-phase current estimation value iu_est and the V-phase current estimation value iv_est is calculated, a correction process can be performed to avoid division by zero and/or multiplication by zero.

(iii) Estimation Based on Differential of α-Axis Current

Since a α-axis current ia and a β-axis current iβ have a relationship between a sine wave and a cosine wave, there is a phase difference of 90[°] between the α-axis current ia and the β-axis current iβ. From this point of view, a β-axis current estimation value iβ_est is calculated based on a α-axis current differential value Δiα. When the calculation in the controller is discrete, the α-axis current differential value Δiα is delayed by a half of an electrical angle change Δθe, i.e., delayed by Δθe/2, with respect to the actual β-axis current iβ. For the above reason, it is preferable that the β-axis current estimation value iβ_est should be corrected by a correction value H which is calculated by multiplying Δθe/2 by an average of previous and present values of the α-axis current ia. Then, a sensor-phase reference current phase θx is calculated based on the α-axis current ia and the β-axis current estimation value iβ_est in the same manner as in the method (ii).

(iv) Estimation Based on a Recurrence Formula

Based on the fact that a W-phase axis relatively rotates on a dq coordinate, a W-phase estimation error Δiw_est is integrated so that d-axis and q-axis current estimation values gradually approach d-axis and q-axis current actual values, respectively.

Specifically, a W-phase current reference value iw_bf which is a component of a sensor-phase is calculated based on previous values of the d-axis and q-axis current estimation value id_est and iq_est, and a present value of the electrical angle θe. Then, the W-phase estimation error Δiw which is a difference between the W-phase current reference value iw_bf and the W-phase current detection value iw_sns is calculated. Then, a corrected error KΔiw is calculated by multiplying the W-phase estimation error Δiw by a gain K which is a filter factor. Then, d-axis and q-axis correction values id_crr and iq_crr are calculated by dq transformation of the corrected error KΔiw under conditions that Δiu=0, and Δiv=0.

Then, the d-axis and q-axis correction values id_crr and iq_crr are defined as a sensor-phase direction correction vector, and d-axis and q-axis current estimation values id_est and iq_est are calculated by integrating the correction vector on a dq coordinate system.

Alternatively, orthogonal direction correction values orthogonal to the sensor-phase can be calculated and defined as an orthogonal direction correction vector, and the d-axis and q-axis current estimation values id_est and iq_est can be calculated by integrating a resultant vector of the sensor-phase direction correction vector and the orthogonal direction correction vector on the dq coordinate system.

In the embodiments, the current estimation value, the current command value, the first voltage command value, the second voltage command value, the voltage command reference value, the deadtime correction value, and the voltage correction value are based on a dq coordinate system. Alternatively, these values can be based on values corresponding to phases of the AC motor or other axes.

The inverter for controlling a voltage applied to the AC motor can be controlled by any method. For example, the inverter can be controlled in multiple modes including a sinusoidal PWM mode and an overmodulation PWM, and a control mode of the inverter can be suitably switched between the modes.

In the embodiments, the current sensor is provided to the W-phase, and the W-phase is defined as the sensor-phase. Alternatively, the current sensor can be provided to the U-phase, and the U-phase can be defined as the sensor-phase. Alternatively, the current sensor can be provided to the V-phase, and the V-phase can be defined as the sensor-phase.

In the embodiments, the current sensor (hereinafter referred to as the “control current sensor”) for detecting a current used for control is provided to one phase. Alternatively, in addition to the control current sensor, a monitor current sensor specialized to monitor whether the control current sensor is normal or abnormal can be added to the sensor-phase or another phase. For example, a “one-phase two-channel configuration” in which both the control current sensor and the monitor current sensor are provided to the sensor-phase can be employed, or a “two-phase one-channel configuration” in which the control current sensor is provided to the sensor-phase, and the monitor current sensor is provided to a phase other than the sensor-phase can be employed. In any configuration, any number of current sensors can be provided to any phase of the AC motor.

In the embodiments, the rotation angle sensor detects and outputs the electrical angle θe to the controller. Alternatively, the rotation angle sensor can detect and output a mechanical angle θm to the controller, and a conversion of the mechanical angle θm to the electrical angle θe can be performed in the controller. Further, the mechanical angle θm can be used as a rotation angle detection value instead of the electrical angle θe. Furthermore, the rotation number speed N can be calculated based on the mechanical angle θm.

In the embodiments, the AC motor is a permanent magnet three-phase synchronous motor. Alternatively, the AC motor can be an induction motor or another type of synchronous motor. In the embodiments, the AC motor is a so-called motor generator serving as not only a motor but also a generator. Alternatively, the AC motor can serve as only a motor.

The AC motor can work as a motor to start the engine. The motor-operated vehicle can have no engine. The motor-operated vehicle can have multiple AC motors. In this case, the motor-operated vehicle can have a force division mechanism for dividing drive forces of the AC motors.

In the embodiments, the motor control apparatus according to the present disclosure is applied to a motor drive system having one set of an AC motor and an inverter. Alternatively, the motor control apparatus can be applied to a motor drive system having multiple sets of AC motors and inverters. Further, the motor control apparatus can be applied to a system, for example, used in a train, having multiple AC motors connected in parallel to one inverter.

Further, the motor control apparatus can be used to control an AC motor mounted on an apparatus or a system other than a motor-operated vehicle.

What is claimed is:

1. A control apparatus for controlling a three-phase AC motor to which a voltage controlled by an inverter is applied, the control apparatus comprising:
a current receiver configured to receive a current detection value from a current sensor which is provided to one of three phases of the AC motor;
a rotation angle receiver configured to receive a rotation angle detection value from a rotation angle sensor that detects a rotation angle of the AC motor;
a rotation speed calculator configured to calculate a rotation speed of the AC motor based on the rotation angle detection value;
a current estimator configured to calculate a current estimation value based on the current detection value and the rotation angle detection value;
a first voltage command value calculator configured to calculate a first voltage command value based on the feedback current estimation value and a current command value related to driving of the AC motor;
a second voltage command value calculator configured to calculate a second voltage command value based on actual behavior information related to an actual behavior of the AC motor, the actual behavior information depending on the rotation angle detection value or a phase angle of a current command vector; and
a control mode switch configured to switch a control mode between a first mode and a second mode based on the rotation speed, wherein
when the rotation speed is greater than a predetermined determination threshold, the control mode switch switches the control mode to the first mode,
when the rotation speed is not greater than the determination threshold, the control mode switch switches the control mode to the second mode,
in the first mode, a drive signal related to driving of the inverter is generated based on the first voltage command value, and
in the second mode, the drive signal is generated based on the second voltage command value.

2. The control apparatus according to claim 1, wherein
the actual behavior information includes a voltage correction value to correct a voltage command reference value which is calculated based on the current command value, and
the second voltage command value calculator calculates the second voltage command value by correcting the voltage command reference value using the voltage correction value.

3. The control apparatus according to claim 1, wherein
the second voltage command value itself is used as the actual behavior information, and
the second voltage command value calculator calculates the second voltage command value from a mapping table based on the rotation angle detection value or the phase angle of the current command vector.

4. The control apparatus according to claim 1, wherein
the actual behavior information depends on a torque command value in addition to the rotation angle detection value or the phase angle of the current command vector.

5. The control apparatus according to claim 2, wherein
the actual behavior information depends on a torque command value in addition to the rotation angle detection value or the phase angle of the current command vector.

6. The control apparatus according to claim 3, wherein
the actual behavior information depends on a torque command value in addition to the rotation angle detection value or the phase angle of the current command vector.
